(19) United States
(12) Patent Application Publication
(10) Pub. No.: US 2015/0123911 A1
(43) Pub. Date: May 7, 2015

(54) INDEX MATCHING AND TOUCH PANEL IMPROVEMENTS IN DISPLAY DEVICES

(71) Applicant: Light Polymers Holding, George Town (KY)

(72) Inventors: Evgeni Poliakov, South San Francisco, CA (US); Samuel Miller, South San Francisco, CA (US); Evgeny Morozov, South San Francisco, CA (US)

(73) Assignee: Light Polymers Holding, George Town (KY)

(21) Appl. No.: 14/072,952

(22) Filed: Nov. 6, 2013

(51) Int. Cl. G06F 3/041

(52) U.S. Cl. CPC G06F 3/0412; G06F 2203/04103
USPC 345/173; 29/829

(57) ABSTRACT

Provided are multilayered touch panel stacks and methods for forming thereof. The stacks include refractive index matching layers to minimize light losses. Specifically, the stacks may comprise a substrate, one, two, three, or four refractive index matching layers deposited on the substrate, and one or two transparent conductive layers such as indium tin oxide electrode layers. The stack may be attached to a light emitting element or be a part of an LCD or OLED displays. The refractive index matching interlayers may be based on a polymer solution having about 0.1%-30% by weight of specific rigid rod-like polymer molecules. The molecules may include various cores, spacers, and side groups to ensure their solubility, viscosity, and cross-linking ability. The refractive index matching interlayer may have a refractive index in between of about 1.60-1.80.

### TECHNICAL FIELD

This disclosure relates generally to touch panel displays and, more particularly, to providing refractive index matching interlayers to touch screen panels and corresponding stacks.

### DESCRIPTION OF RELATED ART

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

Touchscreens, which are also known as touch panels, are widely used in a variety of electronic user devices to display graphic interfaces, images, and data, as well as provide touch control to the users of these devices. Typically, the control can be executed through simple or multi-touch gestures by touching the screen with one or more fingers. Some touchscreens can also detect objects such as a stylus or ordinary or specially coated gloves, including the detection above the touch surface (also known as hovering). The users can use the touchscreens to interact directly with what is displayed, rather than using a mouse, touchpad, or any other intermediate device. Touchscreens are common in devices such as game consoles, all-in-one computers, tablet computers, laptop computers, notebook computers, computer monitors, large displays, smartphones, and similar devices.

There are a variety of technologies for touch sensing that can be integrated into touchscreens. Among most common sensing technologies are resistive touch sensing, surface capacitance based touch sensing, projected capacitance based touch sensing, acoustics, optical, and electromagnetic sensing, and so forth. Most of such sensing technologies require the use of multilayered structures of substantially transparent layers having a variety of purposes. For example, projective capacitive touch (PCT) panels can be made up of a matrix of rows and columns of conductive material layered on sheets of glass. This can be done either by etching a single conductive layer to form a grid pattern of electrodes, or by etching two separate, perpendicular layers of conductive material with parallel lines or tracks to form a grid. Voltage applied to this grid creates a uniform electrostatic field, which can be measured. When a conductive object, such as a finger, comes into contact with a PCT panel, it distorts the local electrostatic field at that point. The change in electrostatic field is then measured to interpret where the user touched the panel and, sometimes, a touch force is also determined.

FIG. 1 shows a high level diagram of an example of touch panel stack 100, which consists of multiple layers including a display device 105 (e.g., a liquid crystal display (LCD), organic light emitting diode (OLED) display, or merely a light emitting device such as a backlight), an air gap 110, substrate 120 (e.g., a glass or hard coat), a first transparent conducting (TC) electrode layer 115 such as a substrate (e.g., glass substrate) with indium tin oxide (ITO) electrodes, a second TC electrode layer 125, an air gap 130, and a top protective layer 135 such as an alkali-aluminosilicate sheet toughened glass. As the top protective layer, for example, impact and scratch resistant glass may be used. The TC electrode layers 115, 125 may be deposited by Plasma Chemical Vapor Deposition (PCVD) technique. Wired lines of these layers may be quite narrow and typically deposited at 250° C. The first TC electrode layer 115 may include rows of conductive material, while the second TC electrode layer 125 may include columns of conductive material, constituting thereby a matrix suitable to sense touches in certain locations. The stack 100, of course, may include additional components, such as polarizing films, twisted nematic liquid crystal layers, retarders, backlights with light sources, diffusers and prismatic/turning films, adhesives, protection coatings, and the like. However these elements are not shown herein so as to not burden the description. In general, multilayered stack reliability and performance depend on how well the layers constituting the stack are matched: optically (refractive index matching), thermo-mechanically (matching of coefficients of thermal expansion), electrically (impedance matching), and so forth.

As will be appreciated by those skilled in the art, as a light beam goes through the touch panel stack (e.g., stack 100), it is subject to multiple reflections, scattering, refractions, and losses at every boundary. The light losses may be as large as about 4% at a typical plastic-air boundary, such as, for example, at the boundary of the top layer 135 and the air gap 130, or even larger between the air gap 110 and the first TC electrode layer 115 or the air gap 130 and the second TC electrode layer 125 as they depend on the refractive index mismatch between the layers and angle of light incidence. The reflections, scattering, and refractions of light of various kinds and natures may generate problems such as unwanted changes in color, brightness, and contrast, in addition to said light losses.

Some touch panels may utilize adhesive layers, such as thermally curable adhesives including ultraviolet (UV) curable materials or pressure-sensitive adhesives (PSA) that are index matched to their substrates in order to reduce light reflection and scattering at the surface of the substrate. FIG. 2 shows a high level diagram of traditional touch panel stack 200 involving the use of PSA. As shown in the figure, the stack 200 may include a display device 205 (e.g., a backlight or LCD cell), a PSA layer 210, a substrate 215 (e.g., a glass or hard coat), a first TC electrode layer 220, a second TC electrode layer 235, an air gap 230 between the first TC electrode layer 210 and the second TC electrode layer 235, a substrate 240, an air gap 245, and a top transparent, protective layer 250. The first and second TC electrode layers 220, 235 may be on separate substrates (as shown on FIG. 2) or on opposite surfaces of a single substrate and may include TC electrode layers. The stack 200 may include additional elements, as will be appreciated by those skilled in the art. It should be also appreciated that just one TC electrode layer may be provided depending on the implementation of the touch sensing technology. Use of the PSA may face difficulties. Specifically, PSAs with optimized refractive indices are typically not available, and the refractive indexes of the PSAs are restricted to 1.6 and typically are about 1.5. The PSA can cause warpage of an entire display when the materials adhered to opposite sides of the PSA have different thermal coefficients of expansion compared to the materials, which they bind.

Design of the touch panel shown in FIG. 2 does not significantly solve light reflections and scattering, resulting in light loss, color distortion, loss of brightness, and contrast problems. Furthermore, the touch panel shown in FIG. 2 does not solve the problem of wired TC layer visibility, both seen under ambient and dark-environment illumination, which greatly affects user satisfaction of many touch panels on the market. In particular, acute human vision can detect a TC wire grid above 100 μm for an untrained eye, and in many instances, can detect the TC wire grid significantly below this resolution. In general, components of touch panels or similar devices require specific refractive index (RI) characteristics, good optical clarity, and other features to allow generated light propagating through a touch panel in certain desired direction(s) with low or even no light losses due to light scattering and reflection. In this regard, one of the crucial requirements for touch stacks lies in reducing or even eliminating light reflection and light losses at every possible boundary of layers used in the touch panel stacks. Second important requirement is the complete obscuration or visibility tempering of the touch grid seen in many types of touch panels. Additional problems may occur during the TC deposition—high temperatures may induce thermal stress to the underneath substrates, which can get damaged, thereby resulting in unwanted scattering through microcracks and additional light loss through the scattering.

One of the major reasons for the problems of light loss, unwanted scattering, and reflection and refraction of light within the stacks 100, 200 is the variation and mismatch of RI (n) among adjacent layers. For example, a typical RI for the substrates 120, 215, 240 is n˜1.5-1.58, a typical RI for the air gap 110, 130, 230, 245 is about n˜1.0, a typical RI value for the PSA layer 210 is n˜1.5, and a typical RI for the TC electrode layers 115, 125, 220, 235 is n˜2.0-2.4 (see FIGS. 1, 2). It is desirable to reduce the above described negative effects of index mismatch without damaging the optical properties of touch panel components, while providing protection, mitigating micro-cracks, and reducing scattering. Moreover, providing an extra layer between the top layer, such as a cover glass, and rather thick TC grid, which obscure the cover glass, may improve the general display visibility and offer extra pleasant viewing experience to the user.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

According to aspects of the present disclosure, provided are multilayered stacks for touch panels and methods for forming thereof. The multilayered stacks include one or more refractive index matching layers to minimize light losses, light leakage, unwanted reflectance, and scattering at the boundaries of otherwise adjacent layers, and conceal the undesired viewing of touch wires. More particularly, the stacks may comprise at least a substrate, one or two refractive index matching layers deposited on surface(s) of the substrate, and one or two transparent conductive layers such as ITO electrode layers. The stack may be attached to a light emitting element or be a part of a LCD or OLED display. In various embodiments, a refractive index of the refractive index matching layer(s) is intelligently selected so as to mitigate the light losses in the stack through Fresnel reflections and also to reduce transparent conductor grid visibility, including complete obscuration. For example, the refractive index of the refractive index matching layer(s) may be between a refractive index of the substrate and a refractive index of the transparent conductive layer(s).

According to aspects of the present disclosure, the refractive index-matching layer includes a polymer solution, which may consist of between about 0.1% and 30% by weight of specific rigid rod-like organic polymer molecules. The molecules may include various cores, spacers, and side groups to ensure their solubility, viscosity, cross-linking ability, and other related processing properties. Deposition techniques of the refractive index-matching layer(s) over the substrate may involve slot die coating, spray coating, molding at various temperatures, roll-to-roll coating, Mayer rod coating, extrusion, casting, embossing, and many more. Various pre-deposition and post-deposition techniques may be employed. At least some pre-deposition techniques may be employed to improve wettability and adhesion to a substrate on which the polymer solution is deposited. Some examples of pre-deposition techniques may include saponification, cleaning, oxidizing, leaching, corona or plasma treatment, depositing a primer layer, and so forth. At least some post-deposition techniques may include UV radiation, infrared (IR) radiation, cross-linking of chemical compounds with a substrate, specific drying techniques, evaporation of solvent, treating with salt solutions, and structure-form shaping.

Alternative or additional embodiments may comprise additional refractive index matching layers, additional non-index matching layers, and layers other than those described herein.

### BRIEF DESCRIPTION OF THE DRAWINGS

Embodiments are illustrated by way of example, and not by limitation in the figures of the accompanying drawings, in which like references indicate similar elements and in which:

FIG. 1 shows an example of a traditional touch panel stack having an air gap.

FIG. 2 shows an example of a traditional touch panel stack having a PSA layer.

FIG. 3 is a high level illustration of a coordinate system associated with a layer coating

FIG. 4 is a high level illustration of a substrate having one surface coated with a polymer film.

FIG. 5 shows a high level block diagram of a method for depositing a polymer solution on a substrate, in accordance with various embodiments.

FIG. 6A shows an example dry thickness dependency against wet thickness for a polymer solution deposited onto a substrate.

FIG. 6B shows an example thickness retardation dependency against dry thickness for a polymer solution deposited onto a substrate.

FIG. 7 shows measured dependencies of viscosity as a function of shear rate for different polymer concentrations.

FIG. 8 shows a high level block diagram of an example touch panel stack that employs a refractive index matching interlayer.

FIG. 9 shows a high level block diagram of another example of a touch panel stack that employs three refractive index matching interlayers.

FIG. 10 shows a high level block diagram of yet another example of a touch panel stack that employs three refractive index matching interlayers.

FIG. 11 shows dependency of refractive indexes of certain layers of optical elements against a wavelength.

FIG. 12 shows in-plane dependency of a refractive index of an index-matching material against a wavelength.

FIG. 13 shows transmission spectra of an example touch panel stack that employs a refractive index matching interlayer.

FIG. 14 shows spectral radiance of an example touch panel stack that employs a refractive index matching interlayer.

FIG. 15 shows a chromaticity diagram for an example touch panel stack that employs a refractive index matching interlayer.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

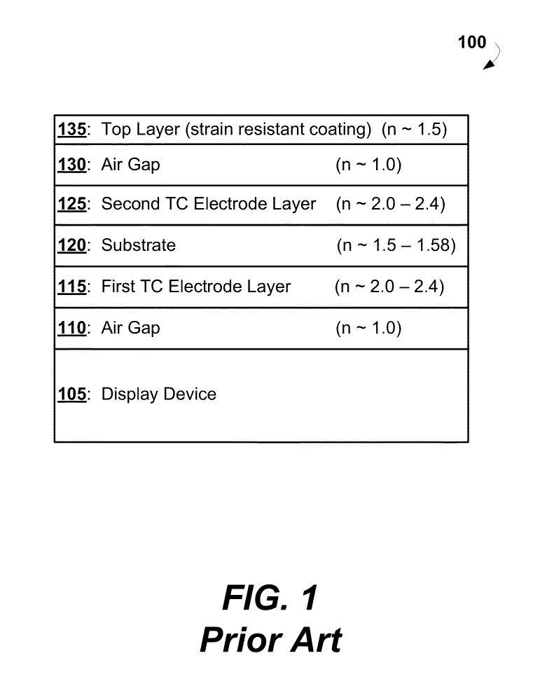

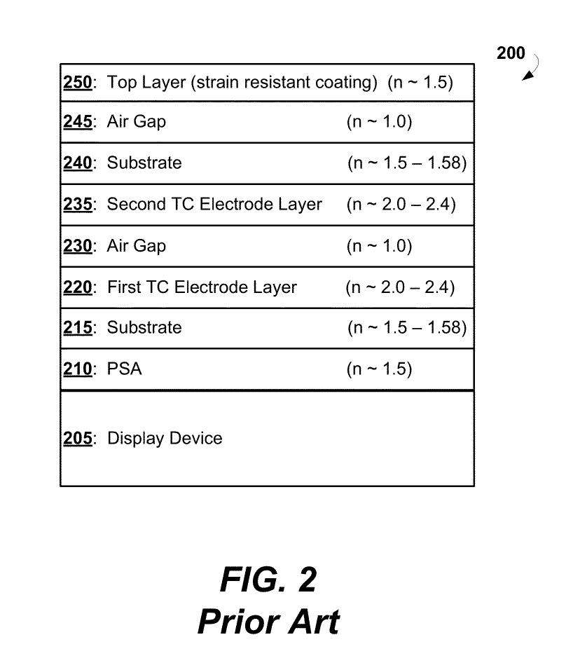

Traditional touch panel stacks are formed by bonding one or more TC electrode layers to a substrate that comprises a part of a display device upper stack, either by using a PSA layer or by providing an air gap therebetween (see FIGS. 1 and 2). Each TC layer may be on a separate substrate or both TC layers may be on opposite sides of a single substrate. These technologies are relatively inexpensive, however, the effect of Fresnel loss reduction is limited as typical inexpensive epoxies used for this purpose have refractive indices less than 1.6 and in most cases, n˜1.5, simply matching the substrate. On the other hand, without refractive index matching layer(s), reflectance and scattering of the image bearing light and/or refraction of ambient light and/or sunlight can seriously impact the quality and visibility of the front of screen image. The image bearing light emitted or transmitted by the stacks 100, 200 and any refracted ambient light are superimposed with corresponding defocusing, color distortion, and brightness/contrast reduction of the transmitted images. Whenever light is incident on the boundary of two media with different refractive indexes, such as layers of touch panel stacks, at least a portion of light may be reflected back into the media through which the light was originally passing, and another portion of light may be refracted into the media towards which it was originally traveling. The reflected light, generally speaking, is a function of the surface roughness of the boundary, the angle of incidence of the light, the wavelength of the incident light, and the ratio of the refractive index of the two media, which is determined by the standard Fresnel expressions. In traditional touch panels, the reflectance losses are typically about 4% for incidence light at 0 degrees for air-plastic interface and is dictated by standard formula R=[n1−n2)/(n1+n2)]². For TC with n1=2.0 and air n2=1.0, even for the normal incidence, the loss can be as large as 11-12%.

In order to decrease light losses, particularly those between the substrate 120 and the first TC electrode layer 115 or the second TC electrode layer 125 or between the substrate 215 and the first TC electrode layer 120, or between the cover glass (top layer) 230 and second TC electrode layer 220, the present technology eliminates the need of leaving air gap(s) 110 and using PSA layer(s) 210, and replaces them with at least one refractive index (RI) matching layer. The RI matching layer(s) may ensure that the differences between refractive indexes between adjacent layers are kept below a predetermined threshold value (e.g., dn=n1−n2<0.20). In other words, the introduction of RI matching layer(s) may ensure reduced Fresnel losses at the boundaries and a reduction of light losses. For example, with a RI matching layer placed in between the substrate 120, 215 and the TC electrode layer 115, 220, the ratio of the RI of the substrate 120, 215 to that of the RI matching layer, and the ratio of the RI matching layer to the TC electrode layer 115, 220, will each be closer to unity. The same is true for placing the RI matching layer between top layer 135 and the second TC electrode layer 125. In other words, RIs for these layers may be evenly distributed such that the RI gradually increases or decreases with the light propagation.

According to embodiments of the present disclosure, the RI matching layer may be a polymer based material, or liquid-soluble material. In an example, applicable polymer materials may include between about 0.1% and 30% or even between 1% and 10% by weight of specific rigid rod-like polymer molecules. Solvents used in the polymer solutions may include a wide range of substances such as polar protic solvents, polar aprotic solvents, and non-polar solvents. The polymer molecules may have a chain length of between about 5,000 and 100,000 unified atomic mass units; however, it should be noted that optimal chain lengths and molecular weights in general may depend on polymer concentration in polymer solution, viscosity, temperature, and many other chemical and physical parameters of a deposition and post-deposition processes. The size of polymer chains allows aligning the polymer molecules at least in the coating direction so as to achieve desired refractive indices for the optical element.

Various deposition techniques may be employed to achieve desired orientation of the molecules or specific optical properties of the deposited polymer solutions. The polymer solutions may be deposited onto a substrate using the following techniques: slot die, spraying, molding, roll-to-roll coating, Mayer rod coating, roll coating, gravure coating, micro-gravure coating, comma coating, knife coating, extrusion, printing, dip coating, and so forth. For example, a slot die technique may involve forcing, under pressure, a polymer solution from a reservoir through a slot onto a moving substrate. The slot may have a much smaller cross-section than the reservoir and may be oriented perpendicularly to the direction of the substrate movement. A combination of the pressure, size of the slot width, gap between the slot and the substrate, and substrate moving speed as well as various polymer solution characteristics described above provide for specific orientation of the molecules.

In touch panel manufacturing, the substrates used for polymer solution deposition may include a polymer substrate, glass substrate, TAC (triacetyl cellulose) substrate, polycarbonate substrate, PET (polyethylene terephthalate), -PMMA (polymethyl methacrylate) substrate, and similar substrates. The substrates may be treated using one or more techniques prior to deposition of the polymer solution so as to improve wettability and/or adhesion of the polymer solution deposited onto the substrate. In particular, the treating techniques may include one or more of the following: cleaning (e.g., ultrasound cleaning), leaching and/or oxidizing using mildly alkaline water solution, saponification, depositing a primer layer (e.g., silane or polyethyleneimine), and modifying surface relief of the substrate by subjecting it to corona discharge or plasma discharge utilizing various gases, vapors, electrons, or ion beams. The pre-deposition techniques may also include an addition of additives to the polymer solutions. The additives may include plasticizing agents, antioxidants, surfactants, formability agents, stabilizers, nonylphenoxypoly glycidol, alcohols, acids, and hindered phenol or other low molecular weight materials and polymers.

Various post-deposition techniques may be employed to stabilize the desired orientation of the molecules and/or specific optical properties. Post-deposition techniques may include, for example, cross-linking, specific drying techniques, techniques to evaporate solvents from polymer solutions, IR light radiation, heating, subjecting to a drying gas flow, shaping, and so forth.

The specifically designed polymers and deposition processes may result in coating layers with high refractive index values, for example, in between about 1.5 and 1.8 within a portion of the visible range, and more specifically between 1.6 and 1.7.

### DEFINITIONS

The term a “visible spectral range” refers to a spectral range having a lower boundary of approximately 400 nm and an upper boundary of approximately 700 nm.

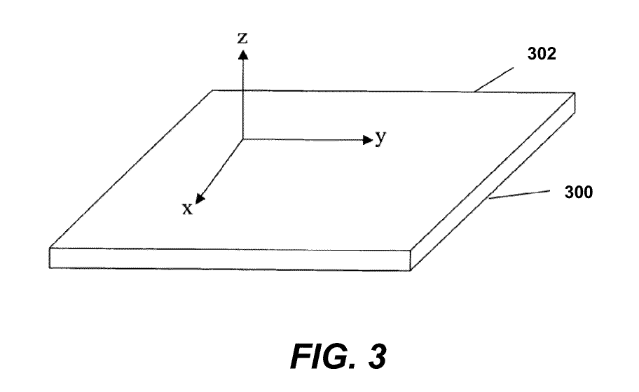

The term “retardation layer” refers to an optically anisotropic layer, which can alter the polarization state of a light wave traveling through the anisotropic layer and which is characterized by three principal refractive indices (nₓ, n_{y}, and n_{z}) associated with the Cartesian coordinate system related to the deposited polymer solution layer or the corresponding optical element based thereupon. Two principal directions for refractive indices nₓ and n_{y} may belong to the xy-plane coinciding with a plane of the retardation layer, while one principal direction for refractive index (n_{z}) coincides with a normal line to the retardation layer. This is further illustrated in FIG. 3, which shows an optical element including a substrate 300 with the deposited polymer solution 302 and an axis system (e.g., Cartesian coordinate system) having orthogonal axes x, y, and z. In various embodiments, at least two refractive indices among nₓ, n_{y}, and n_{z} have different values. The term “retardation layer” may also refer to an optical element that divides an incident monochromatic polarized light into components and introduces a relative retardance or phase shift between them.

The term “optically anisotropic retardation layer of negative C-plate type” refers to an optical layer with refractive indices nₓ, n_{y}, and n_{z} satisfying the following condition in the visible spectral range: n_{z}<nₓ=n_{y}.

The above definitions are invariant to rotation of the system of coordinates (of the laboratory frame) about the vertical z-axis for all types of anisotropic layers.

The term “C-plate” may refer to a uniaxial birefringent optical element, such as, for example, a plate or film, with a principle optical axis (often referred to as the “extraordinary axis”) substantially perpendicular to the selected surface of the optical element. The principle optical axis corresponds to the axis along which the birefringent optical element has an index of refraction different from the substantially uniform index of refraction along directions normal to the principle optical axis (for example, a C-plate using the axis system illustrated in FIG. 3 with nₓ=n_{y}≠n_{z}, where nₓ, n_{y}, and n_{z} are the refractive indexes along the x, y, and z axes, respectively). The optical anisotropy is defined as Δn_{zx}=n_{z}−nₓ. For purposes of simplicity, Δn_{zx} will be reported as its absolute value.

The term “biaxial retarder” may refer to a birefringent optical element, such as, for example, a plate or film, having different refractive indexes along all three axes (i.e., nₓ≠n_{y}≠n_{z}). Biaxial retarders can be fabricated, for example, by biaxially orienting plastic films. In-plane retardation and out of plane retardation are parameters used to describe a biaxial retarder. As the in-plane retardation approaches zero, the biaxial retarder element behaves more like a C-plate. Generally, a biaxial retarder, as defined herein, has an in-plane retardation of at least 3 nm for 550 nm emitting light wavelength. Retarders with lower in-plane retardation are considered C-plates.

The term “polymer” should be understood to include polymers, copolymers (e.g., polymers formed using two or more different monomers), oligomers, and combinations thereof, as well as polymers, oligomers, or copolymers that can be formed in a miscible blend by, for example, coextrusion or reaction, including transesterification. Both block and random copolymers are included, unless indicates otherwise.

The term “polarization” refers to plane polarization, circular polarization, elliptical polarization, or any other nonrandom polarization state in which the electric vector of the beam of light does not change direction randomly, but either maintains a constant orientation or varies in a systematic manner. In plane polarization, the electric vector remains in a single plane, while in circular or elliptical polarization, the electric vector of the beam of light rotates in a systematic manner.

The term “retardation or retardance” refers to the difference between two orthogonal refractive indexes times the thickness of the optical element.

The term “in-plane retardation” refers to the product of the difference between two orthogonal in-plane refractive indexes times the thickness of the optical element.

The term “out-of-plane retardation” refers to the product of the difference of the index of refraction along the thickness direction (z direction) of the optical element minus one in-plane index of refraction times the thickness of the optical element. Alternatively, this term refers to the product of the difference of the index of refraction along the thickness direction (z direction) of the optical element minus the average of two orthogonal in-plane refractive indexes times the thickness of the optical element. It is understood that the sign—positive or negative—of the out-of-plane retardation is important to the user. But for purposes of simplicity, only the absolute value of the out-of-plane retardation will be reported herein. It is understood that one skilled in the art will know when to use an optical element with positive or negative out-of-plane retardation. For example, it is generally understood that an oriented film comprising triacetyl cellulose will produce a negative c-plate when the in-plane refractive indexes are substantially equal and the index of refraction in the thickness direction is less than the in-plane indices. However, herein, the value of the out-of-plane retardation will be reported as a positive number.

The term “substantially non-absorbing” refers to the level of transmission of the optical element of at least 80 percent transmissive with respect to at least one polarization state of visible light, where the percent transmission is normalized to the intensity of the incident, optionally polarized light.

The term “substantially non-scattering” refers to the level of collimated or nearly collimated incident light that is transmitted through the optical element, being at least 80 percent transmissive for at least one polarization state of visible light within a cone angle of less than 30 degrees.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

### Examples of Polymers Applicable for the Use in Refractive Index Matching Interlayers

According to various embodiments, refractive index matching layer(s) may be based on various organic or inorganic polymer solutions. One example of such polymer solution may include a chain of n subunits, where each subunit has a general structure formula (I) as follows:

[-(Core(S)ₘ)ₖ-G₁-]ₙ (I)

The number n of subunits may be between about 5 and 50,000 or, more specifically, between 10 and 10,000. Those skilled in the art should understand that the number of subunits may define physical properties of optical elements based thereupon. For example, when the number of subunits is relatively small, the corresponding polymer chains may be too short to achieve a desired orientation. On the other hand, when the number of subunits is relatively high, the corresponding polymer chains may be too long and cause high viscosity and poor dissolving qualities associated of the polymer. In this regard, the number of subunits and the corresponding chain length may depend on selected organic components (Core), spacers (G), side-groups (S), desired orientation, and particular application.

In various embodiments, the organic components (Core) provide linearity and rigidity of the macromolecule associated with the organic polymer compound having formula (I). The sets of lyophilic side groups (Sₘ) and the number of the organic units n may control a ratio between mesogenic properties and viscosity of the polymer solution. The selection of organic components (Core), the lyophilic side-groups (S), and number of organic subunits n may determine the type and birefringence of the optical film.

In some embodiments, most of the organic units (e.g., more than 90%, more than 95%, or more than 99%) of the polymer are the same. However, in some embodiments, at least one organic subunit is different so that a copolymer may be formed.

Each subunit may consist of conjugated organic components (Core) capable of forming a rigid rod-like macromolecule. These conjugated components may be individually selected from the following list of structural formulas (II) to (X):

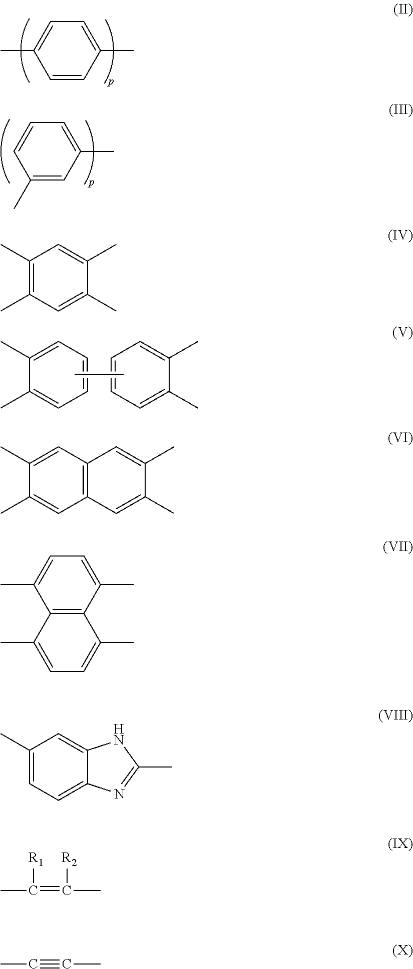

where p is an integer equal to 1, 2, 3, 4, 5, or 6; and where R₁, R₂═H, alkyl. It should be noted that components (II)-(X) may provide linearity and rigidity for the macromolecule while varying in structure.

In certain embodiments, organic components (Core) in each subunit may be of the same type. Alternatively, each organic subunit may include a Core of different type which, in turn, may alter optical properties of optical elements including such a polymer compound. Those skilled in the art should understand that combining the organic components in subunits may affect specific optical properties for the optical element.

Further, each subunit may also include one or more spacers (G). Some examples of spacers include —C(O)—NR1-, ═(C(O))2=N—, —O—NR1-, linear and branched (C1-C4) alkylenes, —CR1R2-O—C(O)—CR1R2-, —C(O)—O—, —O—, —NR1-, where R1 and R2 are independently selected from the list comprising H, alkyl, alkenyl, alkinyl, and aryl.

Further, each subunit may also include one or more lyophilic side-groups (S), which may include lyophilic groups providing solubility to the polymer or its salts in a suitable solvent. In some embodiments, one or more side groups may be hydrophilic groups, such as —COOX, —SO3X, wherein X is selected from the list comprising H, alkyl, alkenyl, alkinyl, aryl, alkali metal, NW4, wherein W is H or alkyl or any combination thereof, and —SO2NP1P2 and —CONP1P2, where P1 and P2 are independently selected from the list comprising H, alkyl, alkenyl, alkinyl, aryl. In the formula (I), the total number of the side groups (m) is 0, 1, 2, or 3.

In various embodiments, said n organic units may include one or more termination components connecting to these n organic units according to the following principle:

T-[-(Core(S)ₘ)ₖ-G₁-]ₙ-T

where T includes one or more of alkenyl, alkynyl, acrylic, or any other UV-curable group.

A number of side groups as well as the number of organic units n may control the ratio between mesogenic properties and viscosity of the polymer. The selection of organic components (Core), the side-groups (S), and number of organic units (i.e., the value of n) determines the type and birefringence of the polymers and corresponding optical element based on the polymers. These polymers may be capable of forming solid optical retardation layers, such as a positive A-type retardation layer, a negative C-type retardation layer or Ac-type retardation layer, based on orientation or disorientation of the polymers and its components. For example, the conjugated component having formula (II) is linear in general, but the conjugated component having the formula (III) is disordered in general. Accordingly, if the subunit includes the conjugated components (II) only, the resulting polymer may have a negative C-type retardation layer. However, once the conjugated components (II) and (III) are combined in subunits, the resulting polymer may have an Ac-type retardation layer.

Molecules have to be rigid and long enough in order to provide ordering during drying. However, both of these factors for polymers in aqueous solutions may lead to a tendency of LLC (lyotropic liquid crystal) formation. This effect is undesirable for one who wants to produce a negative C-plate. In order to suppress LLC formation, one should add certain groups that decrease mesogenic properties, such as the following (but not limited to):

(a) introduction of chain-distorting (non-linear) fragments

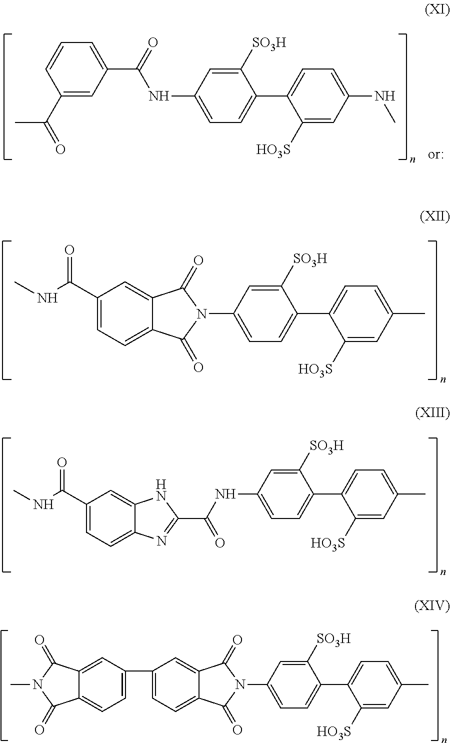

(b) introduction of large fragments, which sterically hinder interaction between chains:

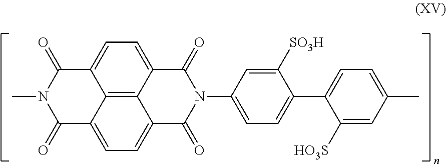

(c) introduction of side-groups, which sterically hinder interaction between chains:

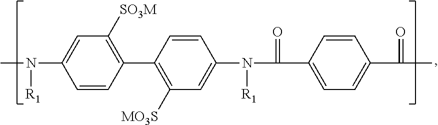

In some embodiments, a polymer may have a specific number of organic compounds and spacers. In other words, a monomer subunit forming the polymer may include, for example, two organic components, one of which has no side groups, while the other has two side groups. The first organic component (Core) may be represented by any of the formulas above (i.e., II (where p=1), III (where p=1), V, VII and VIII). The second organic component (Core) may be represented by the general formula II (where p=2). The side-group (S) may include sulfo-group SO₃H. The first spacer (G) may include C(O)—NH— or =2(C(O))═N—, while the second spacer (G) may include one of —C(O)—, —NH—C(O)—, —N═(C(O))2=. Examples of these subunits or polymers may include: poly(2,2′-disulfo-4,4′-benzidine terephthalamide), poly(2,2′-disulfo-4,4′-benzidine isophthalamide), poly(2,2′-disulfo-4,4′-benzidine 1,3-dioxo-isoindoline-5-carboxamide), poly(2,2′-disulfo-4,4′-benzidine 1H-benzimidazole-2,5-dicarboxamide), poly(2,2′-disulfo-4,4′-benzidine 3,3′,4,4′-biphenyl tetracarboxylic acid diimide), and poly(2,2′disulpho-4,4′benzidine 1,4,5,8-naphtalen tetracarboxylic acid diimide). The corresponding structural formulas (XVI)-(XXI) of these subunits are shown below:

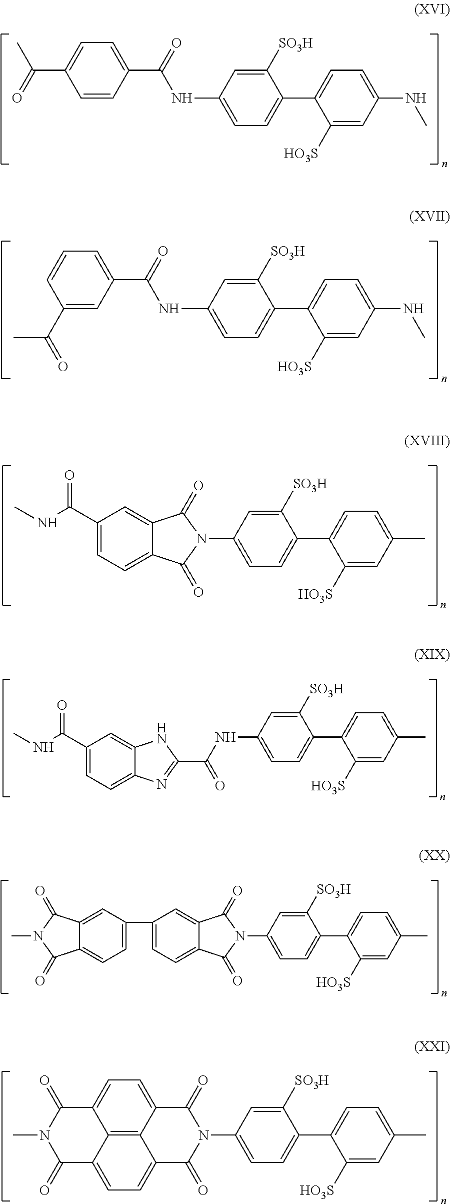

where the number n of subunits may be between about 5 and 500,000.

In yet other embodiments, rigid rod-like macromolecules may be synthesized with n organic subunits of a first type and k organic subunits of a second type. In particular, the first type of organic subunits may include the following general structural formula:

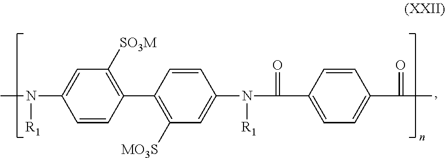

while the second type of organic subunits may include the following general structural formula:

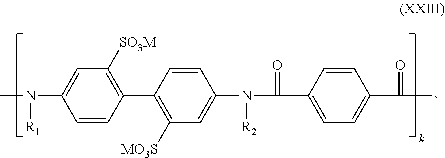

wherein n maybe in the range of 5 to 10,000, and k may be in the range of 5 to 10,000. R₁ and R₂ are side-groups that may be independently selected from the list comprising —H⁺, alkyl, —(CH₂)ₘSO₃M, —(CH₂)ₘSi(O-alkyl)₃, —CH₂-aryl, —(CH₂)ₘOH, where m may include a number from 1 to 18, and in the case of H⁺ as one of the side-groups, the total number of H⁺ should not exceed 50% of total number of side-groups (R₁ and R₂) in the macromolecule. M is counterion selected from the list comprising H⁺, Na⁺, K⁺, Li⁺, Cs⁺, Ba²⁺, Ca²⁺, Mg²⁺, Sr²⁺, Pb²⁺, Zn²⁺, La³⁺, Al³⁺, Bi³⁺, Ce³⁺, Y³⁺, Yb³⁺, Gd³⁺, Zr⁴⁺ and NH₄₋ₚQₚ⁺, where Q is selected from the list comprising linear and branched (C1-C20) alkyl, (C2-C20) alkenyl, (C2-C20) alkinyl, and (C6-C20) arylalkyl, and p is 0, 1, 2, 3 or 4. The organic units of the first type and the organic units of the second type are contained in the rigid rod-like macromolecules in an arbitrary sequence and may comprise polymerization of at least one aromatic diamine monomer having, for example, the following structural formula:

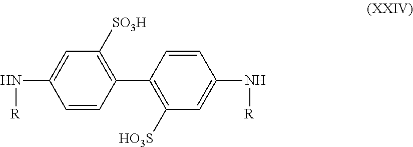

where R is a side-group which is independently selected for different monomers from the list comprising —H⁺, alkyl, —(CH₂)ₘSO₃M, —(CH₂)ₙ—Si(O-alkyl)₃, —CH₂-aryl, and —(CH₂)ₘOH, wherein m is a number from 1 to 18, and at least one difunctional electrophile monomer may have, for example, the following structural formula:

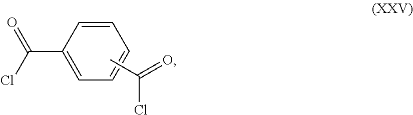

an acid acceptor, and at least two solvents, wherein one solvent is water and another solvent is water-immiscible organic solvent, and wherein an optimal pH of the polymerization step is approximately between 7 and 10.

In various embodiments, one or more salts of the organic polymer solution may be used, such as alkaline metal salts, ammonium, alkyl-substituted ammonium salts, alkenyl-substituted ammonium salts, alkinyl-substituted ammonium salts, aryl-substituted ammonium salts. In various embodiments, the polymer may include one or more inorganic compounds such as hydroxides and salts of alkaline metals. Solvents used for dissolving polymers may include water, any organic solvent, or any combination thereof.

### Examples of Polymer Synthesizing

Reference is now made to the following examples, which are intended to be illustrative of various embodiments of the present disclosure, but are not intended to be limiting the scope.

### Example 1

This example describes synthesis of poly(2,2′-disulfo-4,4′-benzidine isophthalamide) cesium salt (i.e., structure (XII)):

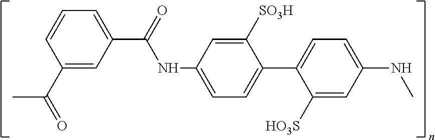

In particular, 1.377 g (0.004 mol) of 4,4′-diaminobiphenyl-2,2′-disulfonic acid was mixed with 1.2 g (0.008 mol) of Cesium hydroxide monohydrate and 40 ml of water and stirred with dispersing stirrer till dissolving, then 0.672 g (0.008 mol) of sodium bicarbonate was added to the solution and stirred. While stirring the obtained solution at high speed (2500 rpm), a solution of 0.812 g (0.004 mol) of isophthaloyl dichloride (IPC) in dried toluene (15 mL) was gradually added within 5 minutes. The stirring was continued for 5 more minutes, and a viscous white emulsion was formed. Then the emulsion was diluted with 40 ml of water, and the stirring speed was reduced to 100 rpm. After the reaction mass had been homogenized, the polymer was precipitated by adding 250 ml of acetone. Fibrous sediment was filtered and dried.

Weight average molar mass of the polymer samples was determined by gel permeation chromatography (GPC) analysis of the sample, which was performed with a Hewlett Packard© (HP) 1050 chromatographic system. Eluent was monitored with diode array detector (DAD HP 1050 at 305 nm). The GPC measurements were performed with two columns TSKgel G5000 PWXL and G6000 PWXL in series (TOSOH Bioscience, Japan). The columns were thermostated at 40° C. The flow rate was 0.6 mL/min. Poly(sodium-p-styrenesulfonate) was used as GPC standard. Varian GPC software Cirrus 3.2 was used for calculation of calibration plot, weight-average molecular weight, Mw, number-average molecular weight, Mn, and polydispersity (D=Mw/Mn). The eluent was mixture of 0.1 M phosphate buffer (pH=7.0) and acetonitrile in the ratio 80/20, respectively. The Mw, Mn, and polydispersity (D) of polymer were 720000, 80000, and 9, respectively.

### Example 2

Example 2 describes synthesis of 2,2′-disulfo-4,4′-benzidine terephthalamide-isophthalamide copolymer cesium salt (copolymer of structures (XI) and (XII):

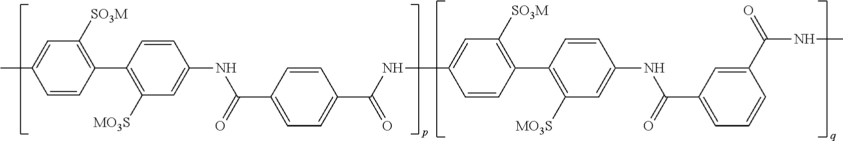

The same method of synthesis as in the Example 1 can be used for preparation of the copolymers of different molar ratio. In particular, 4.098 g (0.012 mol) of 4,4′-diaminobiphenyl-2,2′-disulfonic acid was mixed with 4.02 g (0.024 mol) of cesium hydroxide monohydrate in water (150 ml) in a 1 L beaker and stirred until the solid was completely dissolved. 3.91 g (0.012 mol) of sodium carbonate was added to the solution and stirred at room temperature until dissolved. Then toluene (25 ml) was added. Upon stirring the obtained solution at 7000 rpm, a solution of 2.41 g (0.012 mol) of terephthaloyl chloride (TPC) and 2.41 g (0.012 mol) of isophthaloyl chloride (IPC) in toluene (25 ml) were added. The resulting mixture thickened in about 3 minutes. The stirring was stopped, 150 ml of ethanol was added, and the thickened mixture was crushed with the stirrer to form slurry suitable for filtration. The polymer was filtered and washed twice with 150-ml portions of 90% aqueous ethanol. Obtained polymer was dried at 75° C. The GPC molecular weight analysis of the sample was performed as described in Example 1.

### Example 3

Example 3 describes synthesis of poly(2,2′disulpho-4,4′benzidine 1,4,5,8-naphtalen tetracarboxylic acid diimid)triethylammonium salt (i.e., the structure (XVI)):

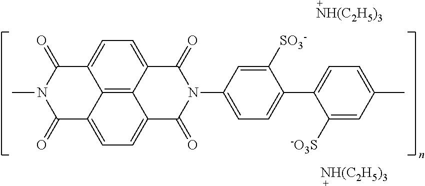

4.023 g (0.015 mol) of 1,4,5,8-naphtaline tetracarbonic acid dianhydride, 5.165 g (0.015 mol) of 2,2′-disulfobenzidine, and 0.6 g of benzoic acid (catalyst) are charged into a three-neck flask equipped with an agitator and a capillary tube for argon purging. With argon flow turned on, 40 ml of molten phenol is added to the flask. Then the flask is placed in a water bath at 80° C., and the content is agitated until a homogeneous mixture is obtained. 4.6 ml of triethylamine is added to the mixture, and agitation is kept on for 1 hour to yield a solution. Then the temperature is raised successively to 100, 120, and 150° C. At 100 and 120° C., agitation is held for 1 hour at each temperature. The solution keeps on getting thicker during this procedure. The time of agitation at 150° C. is 4 to 6 hours.

The thickened solution is diluted with liquid phenol (mixture of water/phenol=1/10 by volume), until a target consistency at 100° C. is obtained, and the resulting mixture is quenched with acetone. Weight average molar mass of the polymer samples was determined by GPC. The GPC analysis of the polymer samples was performed with a Hewlett Packard 1050 HPLC system and the diode array detector (λ=380 nm). The chromatographic separation was done using OHpak SB-804 HQ column from Shodex. Mixture of dimethyl sulfoxide (DMSO) and dimethylformamide (DMF) in proportion of (75:25) respectively, with an addition of 0.05M of lithium chloride (LiCl), was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard. Before the GPC analysis, all samples of the analyzed polymer and the standards were dissolved in DMSO in the concentration of approximately 1 mg/mL.

### Example 4

Example 4 describes synthesis of poly(2,2′-disulfo-4,4′-benzidine 1,3-dioxo-isoindoline-5-carboxamide) cesium salt (i.e., the structure (XIII)).

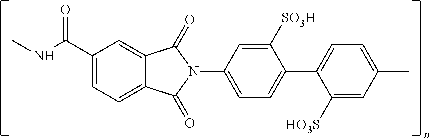

In particular, 2,5-Diaminobenzene-1,4-disulfonic acid (0.688 g, 2.0 mmol), anhydrous N-methylpyrrolidone (10 mL), triethylamine (0.86 mL) and trimellitic anhydride chloride (0.421 g, 2 mmol) were charged subsequently into a two-neck flask equipped with a magnetic stirrer, thermometer, and air condenser with argon inlet. The reaction mixture was then heated up to approximately 130-140° C. and stirred for 24 hours. Then the reaction mixture was cooled to room temperature, and the product was coagulated by slowly dripping the mixture into isopropanol with stirring by magnetic stirrer. The precipitate was collected by vacuum filtration and then suspended in methanol (50 mL) and filtered off. The brown solid was air dried for several hours and then vacuum dried at about 60° C. for 2 hours under P₂O₅ to constant weight 0.16 g.

Weight average molar mass of the polymer samples was determined by GPC. The GPC analysis of the polymer samples was performed with a Hewlett Packard 1050 HPLC system and the diode array detector (A=230 nm). The chromatographic separation was done using the TSKgel lyotropic G5000 PWXL column (TOSOH Bioscience). A mixture of phosphate buffer 0.1 M (pH=6.9-7.0) and acetonitrile was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard.

### Example 5

This example describes synthesis of a rigid rod-like macromolecule of the general structural formula (XVIII), where R₁ is CH₃, M is Cs and k is equal to n.

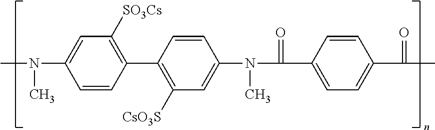

In particular, 30 g 4,4′-Diaminobiphenyl-2,2′-disulfonic acid was mixed with 300 ml pyridine. 60 ml of acetyl chloride was added to the mixture with stirring, and the resulting reaction mass was agitated for 2 hours at 35-45° C. Further, the reaction mass was filtered, and the filter cake was rinsed with 50 ml of pyridine and then washed with 1200 ml of ethanol. The obtained alcohol wet solid was dried at 60° C. Yield of 4,4′-bis(acetylamino)biphenyl-2,2′-disulfonic acid pyridinium salt is 95%.

12.6 g 4,4′-bis(acetylamino)biphenyl-2,2′-disulfonic acid pyridinium salt was mixed with 200 ml DMF. 3.4 g sodium hydride (60% dispersion in oil) was added. The reaction mass was agitated 16 hours at room temperature. 7.6 ml methyl iodide was added and the reaction mass was stirred 16 hours at room temperature. Then the volatile components of the reaction mixture were distilled off and the residue washed with 800 ml of acetone and dried. The obtained 4,4′-bis[acetyl(methyl)amino]biphenyl-2,2′-disulfonic acid was dissolved in 36 ml of 4M sodium hydroxide. 2 g activated charcoal was added to the solution and stirred at 80° C. for 2 hours. The liquid was clarified by filtration, neutralized with 35% HCl to pH-1, and reduced by evaporation to 30% by volume. Then it was refrigerated (5° C.) overnight and the precipitated material was isolated and dried. The yield of 4,4′-bis[methylamino]biphenyl-2,2′-disulfonic acid was 80%.

2.0 g 4,4′-bis[methylamino]biphenyl-2,2′-disulfonic acid and 4.2 g cesium hydrocarbonate were mixed with 6 ml water. This solution was stirred with an IKA UltraTurrax T25 at 5000 rpm for 1 min. 2 ml triethylene glycol dimethyl ether was added, followed by 4.0 ml of toluene with stirring at 20000 rpm for 1 min. Then, a solution of 1.2 g terephtaloyl chloride in 2.0 ml of toluene was added to the mixture at 20000 rpm. The emulsion of polymer was stirred for 60 min and then poured into 150 ml of ethanol at 20000 rpm. After 20 min of agitation, the suspension of polymer was filtered on a Buchner funnel with a fiber filter, and the resulting polymer was dissolved in 8 ml of water, precipitated by pouring into of 50 ml of ethanol, and dried 12 hours at 70° C. The yield was 2.3 g.

### Example 6

Example 6 describes synthesis of UV-curable 2,2′-disulfo-4,4′-benzidine fumarylamide-isophthalamide copolymer sodium salt.

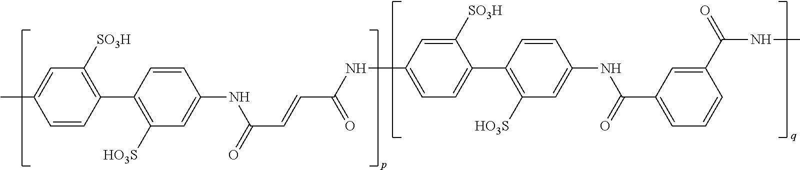

In particular, 15.0 g of 2,5-Diaminobenzene-1,4-disulfonic acid was mixed with 9.7 g of Sodium carbonate in 150 ml of water using a 2 L beaker and stirred until the solid was completely dissolved. Further, 350 ml of toluene was added. Upon stirring the obtained solution at 7000 rpm, a solution of 3.7 g of Fymaryl chloride and 4.9 g of Isophthaloyl chloride in toluene (350 ml) was added. The resulting mixture was stirred for 3 hrs. The stirrer was stopped, 600 ml of Acetone was added, and the thickened mixture was crushed with the stirrer to form a slurry suitable for filtration. The polymer was filtered and washed twice with 350-ml portions of Acetone. The obtained polymer was dried at 75° C. The GPC molecular weight analysis of the sample was performed as described in Example 1.

### Refractive Index Characteristics of Refractive Index Matching Interlayers

Polymer materials including the polymers listed above can be used to form RI matching interlayers. Optical characteristics, such as refractive indices in each direction, regarding RI matching interlayers based on polymers described herein are determined by types of polymers (e.g., their length and rigidity), orientation of the polymers, and other factors. Specifically, optical characteristics may be controlled by selection of organic components (Core), side-groups (S), and the number of subunits (i.e., the value of n). By selecting these components and parameters, one may produce positive A-plates, negative C-plates, and others. In some embodiments, the birefringence of the deposited RI matching interlayer is at least about 0.05 or, more specifically, in between of about 0.05 and 0.20.

In an example, at least one polymer may be formed in a layer forming a plane in the X and Y directions. The X direction may be a coating direction. The layer may have a thickness in the Z direction. In some embodiments, The refractive index in the X direction (i.e., nₓ) may be substantially the same as the refractive index in the Y direction (i.e., n_{y}) and greater than the refractive index in the Z direction (i.e., n_{z}). This type of film may be referred to as a negative C-plate. The refractive indices in the X and Y directions (i.e., nₓ and n_{y}) may be at least about 1.5, at least about 1.6, or even at least about 1.7, while the refractive index in the Z direction (i.e., n_{z}) may be at least about 1.5 or, more specifically, at least about 1.55. For example, polymers for negative C-plates have been shown to have refractive indices in the X and Y directions (i.e., nₓ and n_{y}) of 1.72 and the refractive index in the Z direction (i.e., n_{z}) of 1.59.

Overall, some polymer may be formed into a uniaxial retardation layer such that n_{z}<nₓ=n_{y}.

### Deposition Methods

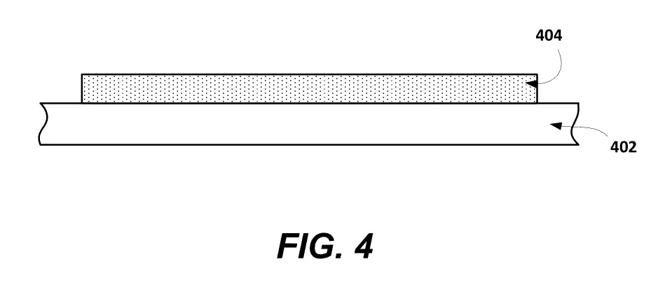

FIG. 4 is a high level illustration showing a substrate 402, one surface of which is coated with a polymer film 404. It should be clear to those skilled in the art that the polymer film 404 may be deposited onto both sides of the substrate 402 or that more than one coating may be applied to one or both sides of substrate 402. The substrate 402 may include, for example, a polymer substrate, a glass substrate, a TAC substrate, a PET substrate, a polypropylene substrate, a polycarbonate substrate, an acryl substrate, a PMMA substrate, and so forth. The substrate 402 may have any suitable form and shape such as flat or having arched plates, or any other complex form depending on an application.

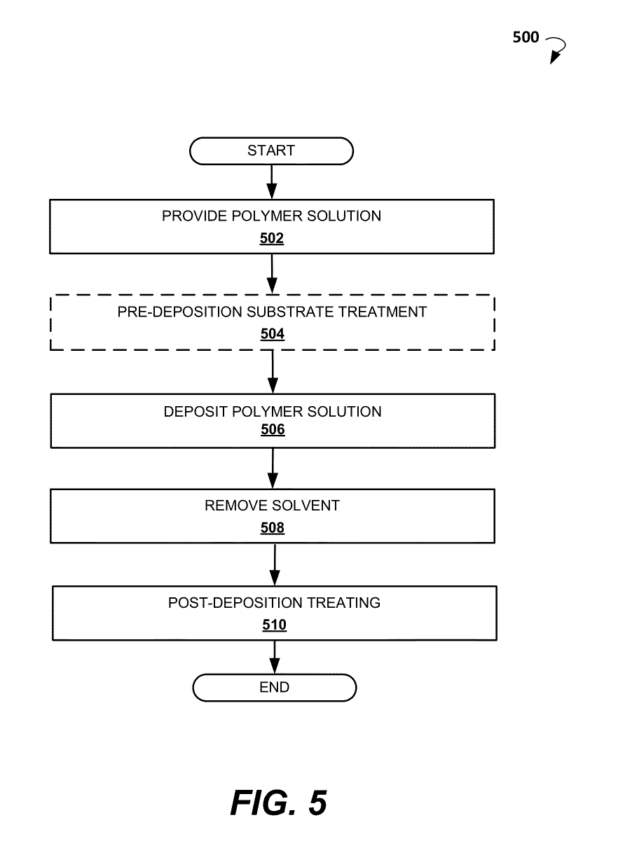

FIG. 5 shows a schematic illustration of a method 500 for depositing a polymer solution on a substrate 402, in accordance with various embodiments of the present disclosure. The method 500 may commence at operation 502 with providing a polymer solution. Various examples of polymer solutions are described above which may include, generally speaking, soluble polymers, such as water-soluble polymers. In certain embodiments, water-insoluble polymers may be also utilized. Soluble polymers such as are described herein may be dissolved in water or other solvents. In various embodiments, solvents may include water, ketones, binary ketone/alcohol mixtures, hydroxyketones, tetrahydrofuran (THF), methyl acetate (MA), and MIBK. In various embodiments, the polymer solution may include one or more additives such as nonylphenoxypoly glycidol, alcohols, acids, plasticizing agents, stabilizers, antioxidants, and hindered phenol. The selection of the additives may depend on particular polymers used, substrate type, and specific purposes.

The polymer solution may be characterized by a solid content, which is defined as a weight ratio of a polymer and other non-solvent components, if present, to the overall weight of the solution. The solid content may be varied to achieve a necessary viscosity and a shrinkage ratio between the wet and dry coating. For purposes of this document, the shrinkage ratio is defined as a ratio of two thicknesses, such as a thickness of the initial coated polymer solution before any drying occurs and a thickness of the fully dry polymer structure (i.e., the structure with the solid content of 100%). In some embodiments, a shrinkage ratio of some intermediate states may be used, such as between a partially dry state and a fully dry state. The solution may be also characterized by a polymer type, molecular weight of the polymer, temperature, and other characteristics. Some of these characteristics may be specific to a particular deposition technique.

In some embodiments, the substrate 402 of FIG. 4 may be pretreated at optional operation 504 to improve adhesion of the polymer to the substrate 402, to introduce cross-linking agents, and other purposes. Some examples of pretreating techniques may include cleaning of substrate 402, saponification, leaching, oxidizing, or modifying surface relief (e.g., by subjecting to corona discharge). Various examples of pretreating procedures are given in the examples below.

At operation 506, the polymer solution may be deposited onto one or more surfaces of the substrate 402 to generate a layer of polymer solution. The wet thickness of this layer may be selected based at least in part on desired dry thickness of the polymer. For example, the ratio of wet thickness to the desired dry thickness of the polymer film may be between about 5% and 20%. It should be also noted that the polymer solution is isotropic prior to deposition.

In general, the polymer solution may be deposited using one or more of the following techniques: a slot die technique, spray technique, molding technique, roll-to-roll coating technique, Mayer rod coating technique, roll coating technique, gravure coating technique, micro-gravure coating technique, comma coating technique, knife coating technique, extrusion technique, printing technique, dip coating technique, and so forth. Some examples of these techniques are described below in more details.

At operation 508, the solvent is removed from the polymer solution deposited onto the substrate 402. The solvent may be removed using one or more techniques including, for example, heating, drying, or subjecting to UV or IR light radiation. Some examples of these techniques are further described below.

At optional operation 510, one or more post-deposition treating techniques may be employed. The post deposition treating techniques may include cross-linking of organic units or shaping of the deposited polymer films. It should be understood that the sequence of operations 508 and 510 may be arbitrary. In certain embodiments, as shown in FIG. 5, the solvent should first be removed, and then a specific post-deposition process may be performed. In certain other embodiments, some post-deposition processes shall be performed first, and then the solvent may be removed. In yet other example embodiments, the operations 508 and 510 are performed simultaneously. Furthermore, in yet other example embodiments, there may be several post-deposition operations 510 which are performed before operation 508 and right after operation 508. Those skilled in the art will appreciate that other example embodiments are possible as well. Below are provided various examples associated with operations 504, 506, 508, and 510.

### Examples of Pre-Deposition Substrate Treating Techniques

In various embodiments of the present disclosure, as stated above, the substrate 402 of FIG. 4 may be subjected to one or more pre-deposition treatments to improve wettability and adhesion of a polymer film deposited thereafter.

In one example of the pre-deposition treatment, a TAC substrate may be subjected to saponification by first rinsing the substrate with water, followed by dipping or coating the substrate with an aqueous solution of sodium hydroxide, followed by additional rinsing, and finally drying. The dipping operation may be between about 0.5 minutes and 5 minutes in duration or, more specifically, between about 1 minute and 3 minutes (for example, about 2 minutes). The aqueous solution may include between about 1% and 20% by weight of sodium hydroxide or, more specifically, between about 2% and 10%, such as about 6%. The solution may be kept at between about 20° C. to 90° C. or, more specifically, at between about 40° C. and 80° C., such as about 60° C. However, it should be noted that the temperature may vary during the saponification process and may depend on multiple criteria.

In another example of pre-deposition treatment, a glass substrate may be subjected to an ultrasonic cleaning using a mildly alkaline water solution. For example, between about 0.1% and 10% by weight (e.g., about 1%) of DECONEX® 12-PA (available from Borer Chemie AG in Zuchwil, Switzerland) may be used for these purposes. The cleaning solution may be kept at a temperature of between about 20° C. and 40° C., such as about 30° C. The duration of the ultrasonic cleaning phase may be between about 0.5 hours and 24 hours or, more specifically, between 1 hour and 5 hours, such as about 2 hours. The glass substrate may be then subjected to soaking and washing with water before subjecting to leaching and oxidizing in an aqueous solution containing between about 1% and 20% by weight of sodium hydroxide or, more specifically, between about 2% and 15%, such as about 15%. The leaching and oxidizing may be performed in an ultrasonic bath for between about 5 minutes and 120 minutes or, more specifically, between about 10 minutes and 60 minutes, such as about 30 minutes. The glass substrate may be then rinsed and dried.

In yet another example of pre-deposition treatment, a thin layer of a primer may be deposited onto a substrate prior to the deposition of a polymer solution layer. The dry thickness of the primer may be between about 10 nm and 200 nm or, more specifically, between about 20 nm and 100 nm such as about 50 nm. For example, silane or polyethyleneimine may be used as primers. A water based polymer solution containing less than 10% by weight of primer or, more specifically, less than 2%, (such as about 0.5%) may be used for this purpose.

Other pre-deposition substrate treatment techniques may include exposing a surface of a substrate to corona discharge, coating a thin layer of a surfactant solution, coating a thin layer of an alcohol, subjecting to electron beam, subjecting to ion beam, subjecting to plasma discharge, and so forth. In any case, the pre-deposition substrate treatment techniques may improve the substrate's adhesion and wettability properties.

### Examples of Deposition Techniques

Below are provided several examples of deposition techniques used for applying a layer of polymer solution onto a substrate.

### Slot Die Extrusion Example

The slot die technique is generally suitable for depositing uniform layers having a thickness in the range of about 1 micron to about 2000 microns (wet), using solutions (or slurries) having viscosities of 1 cP to 100,000 cP and maintained at temperatures of up to 250° C., and using linear speeds of up to 500 meters per minute. The viscosity of the coated polymer may be controlled by molecular weight, solid content, additives, and temperature. Viscosity may impact flow characteristics of polymer solutions, shear stresses applied to the forming film and, as a result, the alignment of polymer molecules within a deposited layer and resulting optical characteristics of the layer. The polymer solution temperature, which may be referred to as a feeding temperature, may be between about 10° C. and 80° C. Below 10° C., the water in a water soluble polymer gets closer to its freezing point, while temperatures above 80° C. may cause rapid evaporation and loss of water, which results in a system that may be difficult to control. Before deposition, it should be ensured that the polymer solution is homogeneous, which may be done by warming and/or stirring. At this step, one or more additives may be added to the polymer solution based on an application or certain tasks.

The provided solution is then deposited onto the substrate as a thin layer. As noted above, the polymer solution may be deposited onto a substrate or be formed into freestanding structures, according to one or more embodiments described above. The thickness of the deposited layer may depend on one or more of the following: a substrate feed speed, substrate width, polymer solution feed rate, and solids content. The substrate feeding speed may be between 0.5 meters per minute and 500 meters per minute or, more specifically, between 2 meters per minute and 20 meters per minute. While faster speeds are beneficial from the process throughput perspective, the feeding speed may be controlled to achieve specific shear forces for redistributing and aligning polymer molecules within the deposited layer. The feeding rate of the polymer solution may be between 1 gram per minute and 2500 grams per minute. In some embodiments, deposited film thickness may be between 10 microns and 2000 microns or, more specifically, between 25 microns and 250 microns. This is the thickness of the wet coating and changes substantially during drying. As noted above, the degree of change, i.e., the shrinkage ratio, depends on the solid content and other factors.

When the slot-die technique is used, slot die lips may be separated by a distance between 10 microns and 1000 microns or, more specifically, between 25 microns and 250 microns. The lip separation may determine pressure in the die and therefore film thickness uniformity. Additionally, the slot die is spaced relative to the substrate and allows the polymer solution to flow onto the substrate and be deposited as a uniform layer. In some embodiments, the gap between the slot die and the substrate is between 10 microns and 1000 microns or, more specifically, between 25 microns and 250 microns, and may be varied to control coating quality.

In order to better understand some equipment based parameters, such as spacer thicknesses, substrate feeding speed, and solution feeding rates, a brief description of the slot die coating system may be helpful. A slot die coating system may include five main components: a die, a die positioner, a roll, a fluid delivery system, and a substrate. The die determines the rate of polymer solution dispensing onto the substrate. The fluid rheology (e.g., pressure, viscosity, and surface tension) is a contributing factor together with a design and position of the die. Some polymer based solutions have specific rheological properties that require specific design of the die (e.g., the internal flow geometry). The die manifold is the contoured flow geometry machined into the body sections of the die. The function of the die is to maintain the solution at the proper temperature for application, distribute it uniformly to the desired coating width, and apply it to the substrate. The manifold distributes the coating fluid that enters the die to its full target width, and is designed to generate a uniform, streamlined flow of material through the exit slot of the die. The die positioner is an adjustable carriage that precisely positions the slot die at the optimum angle and proximity to the roll and isolates the die from vibrations that can affect coating application. The die positioner stabilizes the interaction between the die and the moving substrate, sets the angle of dispensing between the die and substrate, and sets the distance between the die and substrate. The roll provides a precisely positioned surface with respect to the die position and is used for supporting the substrate. The fluid delivery system is used to provide a constant feed of polymer solution into the die. The delivery system may determine the coat weighting weight and thickness of the deposited layer.

### Roll-to-Roll Deposition Example

When a roll-to-roll technique is used (which is also known as web processing or reel-to-reel processing), a polymer solution may be deposited on a substrate presented in the form of a roll of film. The deposition may be made using any suitable technique. In an example, the deposition may include the use of an applicator, which may be adjusted by a shear force (a knife) on a moving substrate. The deposition may be performed such that a further drying technique is applied, or UV cross-linking techniques are utilized as described below. Once the substrate film has been coated, it is rolled onto another roll and may then be slit to a desired size on a slitter and/or cut to final size on a shear or be further processed by embossing, subjecting to high-temperature, or dipping in barium chloride solution (alone or combined) as further described below.

As noted above, before deposition, homogeneity of the polymer solution should be ensured. The web speed and/or coating solution flow rate should be set so as to control desired shear stress and coating thickness. The polymer solution solids concentration and feed temperature should be also set.

In an example, the substrate was coated with the polymer solution to exhibit a negative C-plate behavior with out of plane retardation values (Rth) defined as:

Rth=thickness*(nz−nx)

The Rth values may be controlled by dry coating thickness. Table 1 below shows various wet thicknesses achieved during the deposition technique of a polymer containing 2,2′-disulfo-4,4′-benzidine terephthalamide-isophthalamid (hereinafter referred to as “POLYMER 1”) of known solids concentration (N) and flow rate through an 11-inch wide shim at 25 ft/min.

TABLE 1

| | | | | Calculated | Measured | |
|---|---|---|---|---|---|---|
| | Coat | Web | Flow | wet | dry | Measured - |
| N | width | speed | rate | thickness | thickness | Rth @ 550 nm |
| % | ft | ft/min | g/min | micrometer | Micrometer | Nanometer |
| 4.0 | 0.92 | 25 | 89.2 | 41.9 | 1.36 | 177 |
| 4.0 | 0.92 | 25 | 136.4 | 64.1 | 2.07 | 250 |
| 4.0 | 0.92 | 25 | 143.7 | 67.5 | 2.26 | 261 |
| 7.1 | 0.92 | 25 | 218.8 | 182.4 | 5.85 | 587 |

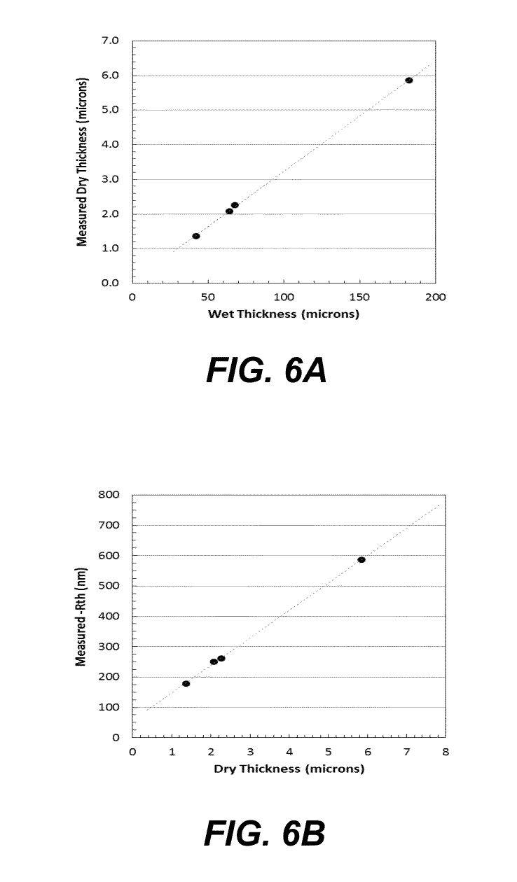

The dry thickness measurement of the deposited polymer solution is linear with the set wet thickness (though not exactly by 4% since the polymer film compacts upon drying). It can be predicted that the measured Rth is linear with the thickness of the POLYMER 1 layer. Thus, the retardance may be controlled through the deposition conditions and characteristics. This is further illustrated in FIGS. 6A and 6B, which show dry thickness dependency against wet thickness (FIG. 6A) and retardation dependency against dry thickness (FIG. 6B). It should be noted that the wet thickness vs. dry thickness curve will change with the solid concentration of the applied solution.

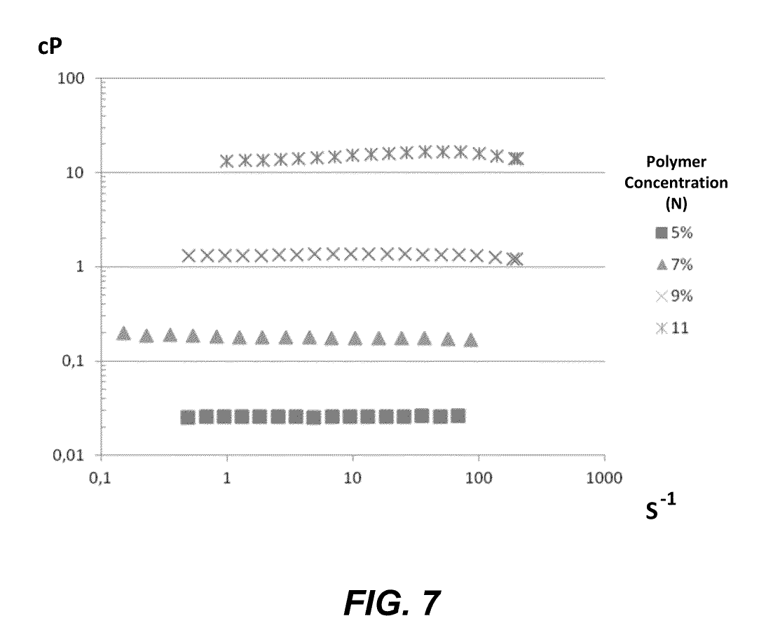

As already noted, the viscosity of the coated polymer solution may be controlled by various parameters such as a molecular weight, solid content concentration, temperature, and so forth. Viscosity may also impact flow and characteristics of polymer solutions, shear stresses applied to the forming polymer solution film and, as a result, alignment of polymer molecules within a deposited layer and resulting optical characteristics of the optical layer. FIG. 7 shows measured dependencies of viscosity (cP) as a function of shear rate (s⁻¹) for different polymer concentrations (N).

### Mayer Rod Coating Example

Mayer rod coating is one of the most popular small area (1-100 sq, inches) coating methods. The technique allows depositing films with a thickness in the range of 1 to about 100 microns (wet). A typical viscosity of the coating liquid is in the range of 20-1000 cP. A Mayer rod is a stainless steel rod that is wound tightly with stainless steel wire of varying diameter. The rod technique is used to doctor of the excess coating solution and control the coating weigh. The maximum coating speed is around 250 m/min. The wet thickness after doctoring is controlled by the diameter of the wire used to wind the roll and is approximately 0.1 times the wire diameter. Mayer rods are available in a wide variety of wire sizes to allow for a range of coating weights. The dry thickness may be determined by concentrations of solids in the coating solutions. The thickness variation is usually within 10%. The coating can be performed manually by a drawdown machine or automatically with a motorized film applicator.

### Examples of Removing Solvent Technique

Now, returning back to FIG. 5, at operation 508, solvent is removed from the deposited polymer solution. The solvent may be removed by drying at temperatures of at least about 80° C. The upper limit is generally determined by the stability of the polymer used in the solution. These temperatures may represent the actual temperature of the material during its drying or the temperature of surrounding components, such as the temperature of the substrate, the temperature of atmosphere over the surface of the material, and the like. The drying may be also performed by blowing drying gas at specific temperatures. For example, the drying gas may include nitrogen or heated air. In general, higher temperatures are preferred to expedite the drying process. However, fast removal of water may disturb the arrangement of polymer molecules within the drying structure and distort optical properties.

In certain example embodiments, the drying process may include multiple steps. For example, the drying by heating may also include subsequent cooling of the polymer solution. In various embodiments, one or more drying devices may be utilized such as flash dryers, rotary dryers, spray dryers, fluidized bed dryers, vibrated fluidized beds, contact fluid-bed dryers, plate dryers, and so forth.

### Post-Deposition Treating Techniques

### Cross-Linking

The post-deposition treating operation 510 may also involve cross-linking of polymer chains by one or more of the following techniques: UV light radiation, IR light radiation, or other types of activation energy sources such as electron, ion, or gamma radiation. In certain embodiments, cross-linking of polymer chains may include subjecting the polymer molecules to a reaction with specific additives or proprietary compositions. The cross-linking may involve forming links between two or more adjacent polymer molecules and/or extending polymer molecules by linking end groups. Examples of UV sensitive groups responsible for cross-linking may include carbon double bonds and carbon triple bonds. The groups may be introduced into some or all monomers during their synthesis. The groups may be relatively inactive during coating and partial or even entire drying operations but capable of activating after coating and, in some embodiments, after partial or complete drying. In various example embodiments, UV light radiation may have specific wavelengths, for example, the range between about 180 nanometers and 400 nanometers.

One example of UV cross-linking will now be described in more detail. A polymer as shown below may be formed into a negative C-plate. When a deposited polymer film is subjected to UV light irradiation, the irradiated polymer film becomes less soluble before any further post-treatment, such as exposure to metal cations for cross-linking. Without being restricted to any particular theory, it is believed that double bonds present in each polymer molecule react under UV-irradiation to form inter-molecular bonds with adjacent molecules. Below is shown an example cross-linking of polymers having structural formulas:

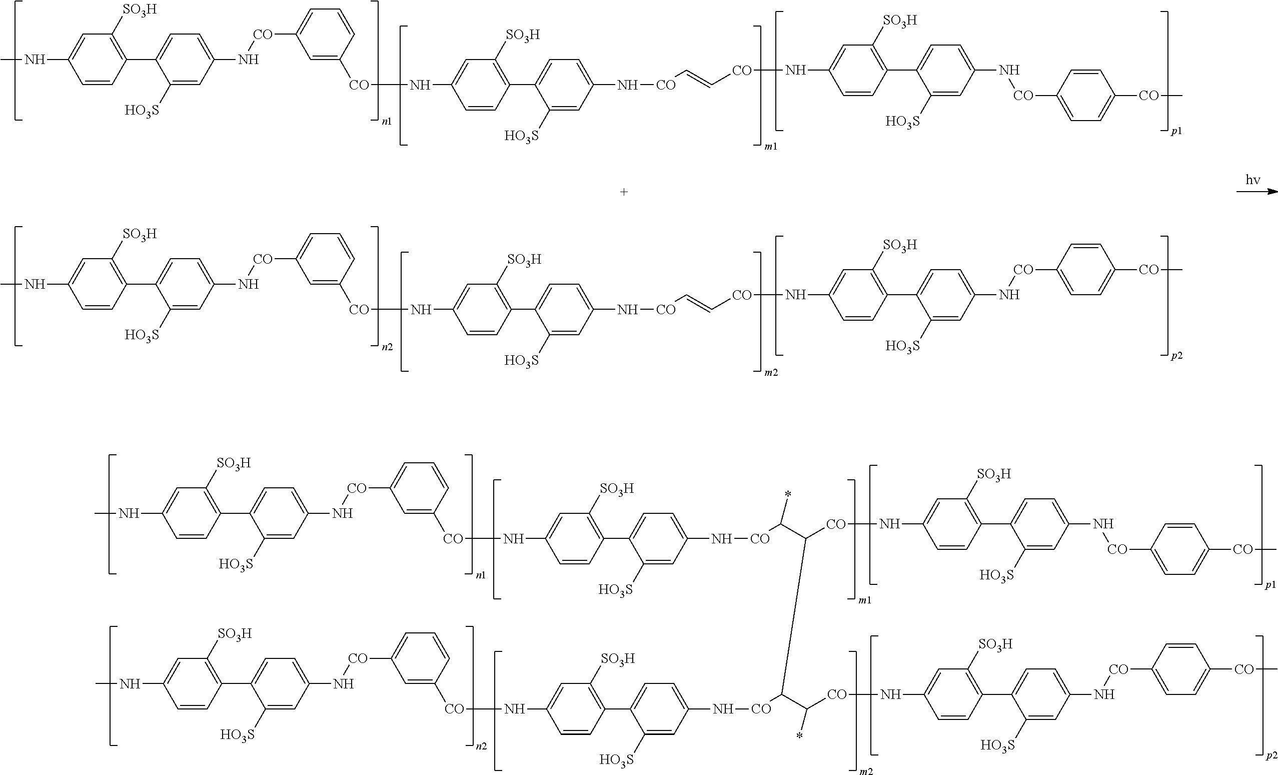

Another example is presented by the formula shown below. The polymer uses chain terminators to control the molecular weight. Without these chain terminators, the material may extend to a molecular weight of 220,000 units and become insoluble. With the chain terminators, the molecular weight may be reduced to about 20,000 units and has sufficient solubility. These chain terminators may be UV-curable groups (e.g., C═C double and C—C triple bonds) that could be easily activated to increase the molecular weight in the film after coating, provide a 3D network, and reduce solubility. This example is further illustrated by the following structural formulas:

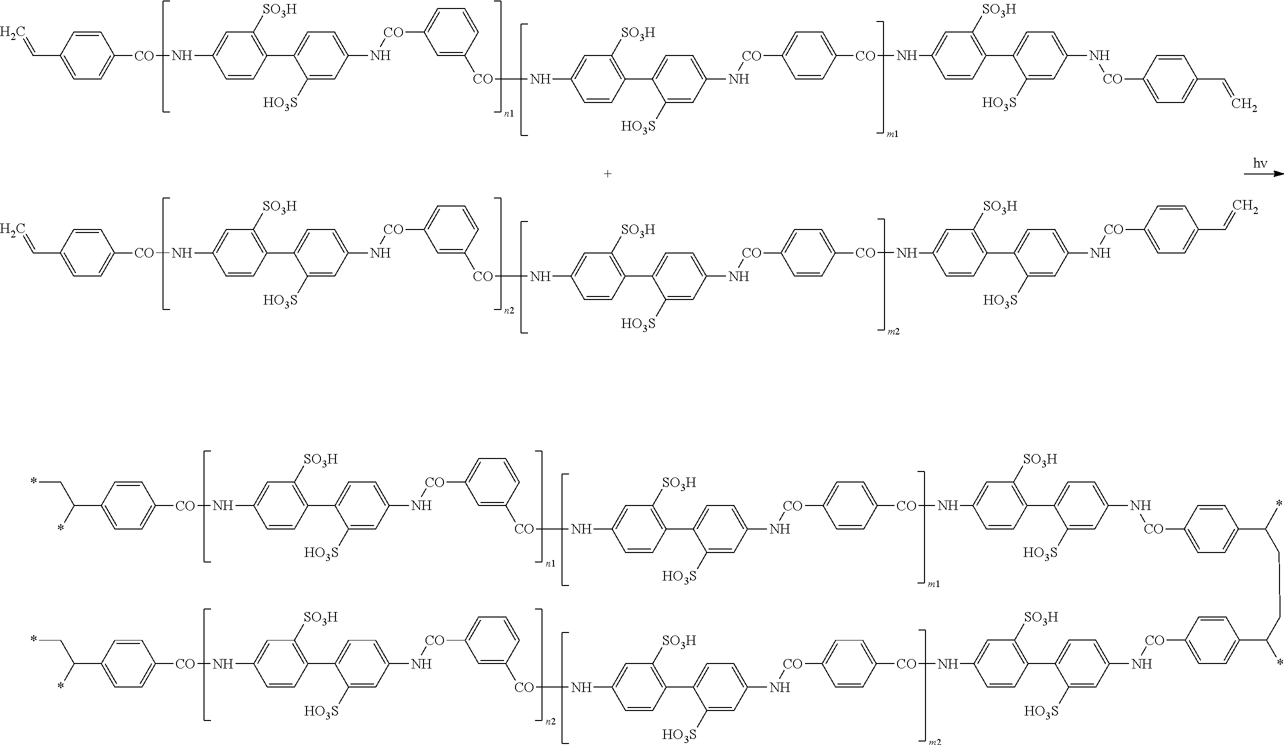

Asterisks as shown above designate continuations of the polymeric chains.

### Examples of Touch Panel Stacks Utilizing Refractive Index Matching Interlayers

As it was already discussed above, the problem of RI mismatch between elements and layers of touch panel stacks can be solved by introducing one or more buffer interlayers in between elements having such distinctive refractive indexes and/or instead of an air gap or PSA layers. The buffer interlayer, which is also referred to as a refractive index matching layer, may be based on polymer solutions discussed herein (although it may be based on other materials) and may have a specific RI, and also a specific thickness between tens of nanometers to sub-micron levels. The refractive index value of this buffer interlayer can be predetermined and selected in between the RIs of corresponding neighbor layers. For example, the RI value of a refractive index matching layer may be a geometrical average value of the RI values of an adjacent substrate, air gap, and TC electrode layer. It has been demonstrated by the authors of this disclosure that the refractive index matching layer may provide index-matching for elements of a touch panel stack and reduce various unwanted light losses, light reflections, scattering, and/or reflections at the layer boundaries. In certain embodiments, the polymers of the present disclosure may have in-plane (i.e., XY plane) retardation approaching zero, which makes them isotropic in plane and anisotropic in light propagation direction, thus very effective for the purposes of index matching and reducing light losses of various kinds and natures. Yet, in another embodiment, the index matching layer of not necessarily the same thickness, which is used for light enhancement by mitigating the optical losses due to the interference mismatch, is applied towards the TC grid obscuration with close to zero or minimal color shift in ambient light.

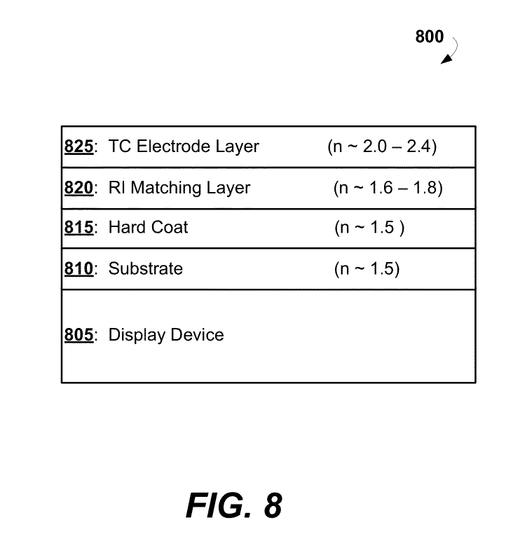

FIG. 8 shows a high level block diagram of an example touch panel multilayer stack 800 that employs a refractive index-matching interlayer. As shown in the figure, the stack includes a display device 805, a substrate or base layer 810, an optional hard coat layer 815, an RI matching layer 820, and a TC electrode layer 825. The TC electrode layer 825 may include ITO, fluorine doped tin oxide (FTO), silver nanowires, copper nanowires, carbon nanotubes, and the like. The stack 800 may include additional elements including, for example, a polarizing layer, a top protective layer, adhesive layers, and so forth. These additional and/or optional layers are not shown.

Methods for forming the stack 800 may involve, for example, the following operations. First, the substrate 810 is provided, which is also known as a base structure, and may include a layer of PET material, a layer of TAC material, a PMMA layer, glass, and so forth. The substrate 810 is then covered with the index-matching layer 820 following one or more deposition techniques described above with reference to FIG. 5. It should be noted that one or more pre-deposition and/or post-deposition techniques may also be implemented. For example, some pre-deposition techniques can be implemented to improve adhesion and/or to remove solvents, and/or some post-deposition techniques can be performed to provide cross-linking of a polymer solution used in the RI matching layer 820. Detailed description of pre-deposition and post-deposition processes is not repeated in this section so as not to burden the description of index-matching principles. A thickness of the RI matching layer 820 may be controlled and selected anywhere between a lambda/4 to lambda/2. The refractive index of the RI matching layer 820 may be also controlled and selected anywhere in between about 1.6-2.0, or more specifically in between 1.6-1.8 depending on an application. In an example embodiment, the RI matching layer 820 may be based on a polymer solution as described herein.

After deposition of the RI matching layer 820, the TC electrode layer 825 may be deposited over the RI matching layer 820 using one or more deposition techniques (e.g., CVD (chemical vapor deposition), PCVD, APCVD (atmospheric pressure CVD), LPCVD (low pressure CVD), RPECVD (plasma enhanced CVD), MPCVD (microwave plasma CVD), and HPCVD (hybrid physical-chemical CVD) techniques or the like).

Furthermore, the assembled structure of layers 815-825 may be attached to the display device 805 and/or the hard coat 810. The display device 805 may refer to merely a light emitting or light transmitting device (e.g., a backlight), or alternatively it may refer to at least a part of LCD, LCD cell, OLED display, or the like apparatus. The hard cover 810 may refer to a TAC film, PMMA film, or any other substantially transparent and protective layer.

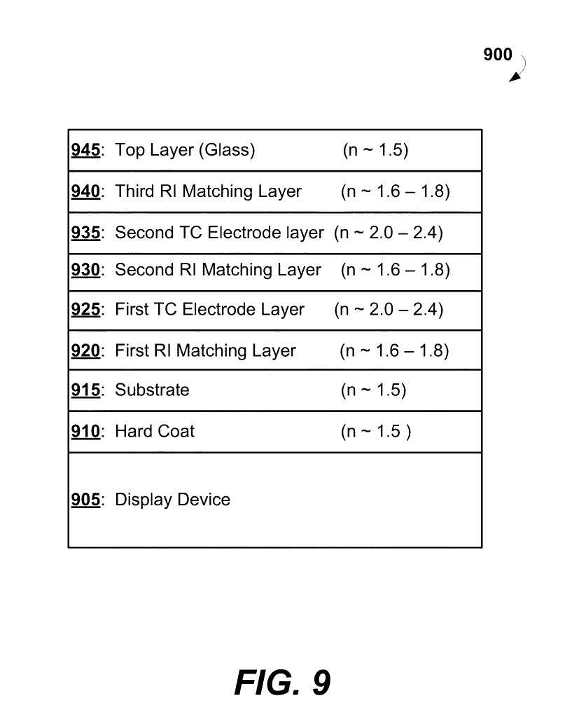

FIG. 9 shows a high level block diagram of another example touch panel stack 900 employing three refractive index-matching interlayers. Similar to FIG. 8, the touch panel stack 900 may include a display device 905 over which an optional hard coating 910 may be provided (e.g., TAC, PET, PMMA or alike layer). The stack 900 further includes a substrate 915, such as a PET or TAC substrate, a first RI matching layer 920, a first TC electrode layer 925, a second RI matching layer 930, a second TC electrode layer 935, and a third RI matching layer 940. The stack 900 may further include a substantially transparent protection top layer 945, which is typically glass. In an example embodiment, the stack 900 may further include a fourth RI matching layer (not shown) deposited over the third RI matching layer 940. The stack 900 may include additional elements including, for example, polarizing layers, top protective layers, strain resistant coatings, adhesive layers, and so forth. These additional and/or optional layers are not shown.

Methods for forming the stack 900 may involve the following example operations. First, the substrate 915 is provided, which may include a layer or PET material, layer of TAC material, PMMA layer, glass, and so forth. The substrate 915 is then covered with the first RI matching layer 920 and the first TC electrode layer 925 using one or more deposition CVD-based techniques (e.g., PCVD, APCVD, LPCVD, RPECVD, MPCVD, HPCVD techniques or the like). Further, the second RI matching layer 930 is then deposited over the first TC electrode layer 925 following one or more deposition techniques described above described above with reference to FIG. 5.

Further, the second TC electrode layer 935 is then deposited over the second RI matching layer 930. Further, the third RI matching layer 940 may be deposited on the second TC electrode layer 935. The first, second, and third RI matching layers 920, 930, and 940 may provide or facilitate touch sensitivity to the touch panel. The RI matching layers 920, 930, and 940 may be of a minimal thickness, essentially uncontrolled, or controlled and selected anywhere between a lambda/4 to lambda/2. An RI matching layer of controlled thickness may be useful for such purposes as controlling ambient light striking the surface of the screen. The refractive index of the RI matching layers 920, 930, and 940 may be also controlled and selected anywhere in between about 1.6-2.0, or more specifically in between 1.6-1.8 depending on an application. In an example embodiment, the first, second, and third RI matching layers 920, 930, and 940 may be based on polymer solution as described herein. It should be also clear that the first, second, and third RI matching layers 920, 930, and 940 may having different materials. In particular, the refractive index of the third RI matching layer may be between the refractive index of the second TC layer and the refractive index of the top layer.

Furthermore, the optional fourth RI matching layer may be deposited on the third RI matching layer 940. The top layer 945 is then deposited on the optional fourth RI matching layer. The third RI matching layer 940 or, if present, the fourth RI matching layer, may be deposited in such a way that there exists an air gap (not shown) between the third RI matching layer 940 or, if present, the fourth RI matching layer and the top layer 945.

In another example embodiment, an index matching PSA (not shown) may be deposited over the third RI matching layer 940. The index matching PSA may be deposited so as to be located between the third RI matching layer 940 and the top layer 945.

Furthermore, the assembled structure of layers 915-945 may be attached to the display device 905 and/or the hard coat 910. The attachment may be made by an air gap (not shown), depending on the nature of the first RI matching layer 910, or a suitable index matching PSA. The display device 905 may refer to merely a light emitting or light transmitting device (e.g., a backlight), or alternatively it may refer to at least a part of a LCD, LCD cell, OLED display, or a like apparatus. The hard cover 910 may refer to a TAC film, PMMA film, or any other substantially transparent and protective layer.

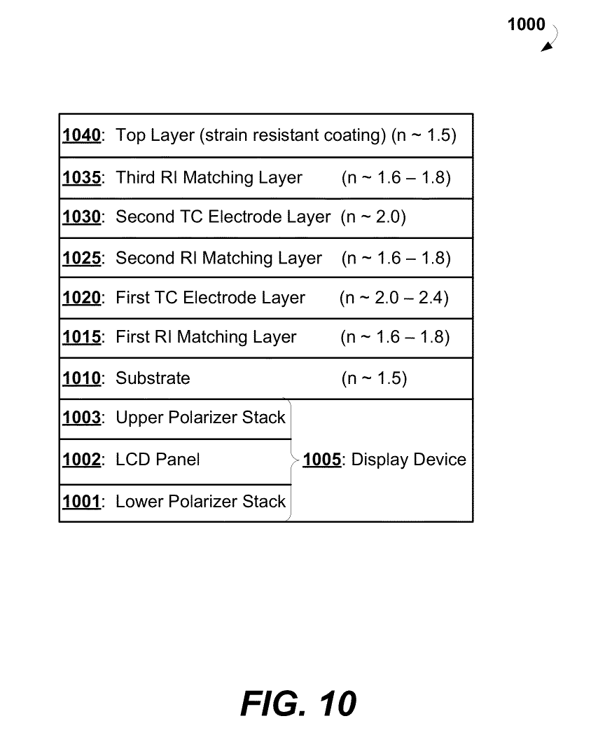

FIG. 10 shows a high level block diagram of yet another example touch panel stack 1000 employing three refractive index-matching interlayers and also polarizers. As shown, the touch panel stack 1000 may include a display device 1005 consisting of a lower polarizer stack 1001, an LCD panel 1002, and an upper polarizer stack 1003. The stack 1000 further includes a substrate 1010, e.g. a PET substrate, a first RI matching layer 1015, a first TC electrode layer 1025, a second RI matching layer 1025, a second TC electrode layer 1030, a third RI matching layer 1035, and a transparent, protective top layer 1040. In an example embodiment, an optional fourth RI matching layer (not shown) may be deposited over the third RI matching layer 1035. The structure of stack 1000 is similar to the structure 900, and thus methods of its forming are very much alike and it would not be repeated herein.

In general, multilayer dielectric theory provides that to match two layers with different refractive indexes, n1 and n2, an interlayer should possess the following refractive index:

n(interlayer)=(n1·n2)^{1/2}

and the thickness t=lambda/4n to minimize the reflection.

Given the above examples of FIGS. 8-10, the refractive index of the substrate 810, 915, 1010 may be about n1˜1.5 and the refractive index of ITO electrode layers may be about n2˜2.0-2.4. Thus, the refractive index of RI matching layers should be n(interlayer)˜1.73-1.90. Taking into account that the polymer materials described herein may have the refractive index within about 1.6-1.8, these materials are perfect candidates for being a refractive index matching interlayer. In certain embodiments, the refractive index of RI matching layers may be an average value of refractive indexes of adjacent or neighboring layers.

In addition to above, the RI matching layers may provide light collimation. Whenever light is transmitted via the boundary of two media with different refractive indexes, some light is reflected back into the media through which the light was originally passing, and some is refracted into the media towards which it was originally traveling. Light collimation may be an important aspect of touch panel stacks or similar display devices. Ideally, light should propagate normal to the surface of key layers such as the ITO electrode layer. That said, introduction of RI matching layer(s) based on polymers disclosed herein possessing predetermined refractive index may enable or improve light collimation not only within the RI matching layer, but also in other layers of touch panel stacks.

In addition to above, it should be noted that polymer materials discussed herein are very stable against heating (e.g., 150° C. or even more). In this regard, RI matching layers based on the polymers discussed herein may also provide thermal protection to a substrate or related layers of discussed touch panels. Indeed, while many deposition or cross-linking techniques require heating of certain elements, plastic or glass substrates may be easily damaged by the formation of multiple micro-cracks on their surfaces. This damage may lead to light distortion and unwanted worsening of optical characteristics. However, when a refractive index-matching layer based on the polymers discussed herein is applied to the substrate, it may not only protect against overheating and reduce the number of micro-cracks appearing in the substrate, but it may also fill those cracks that are present on the face surface of the substrate during the deposition process or after post-deposition steps. Thus, the polymers of the present disclosure are very attractive materials for various multi-layered display devices.

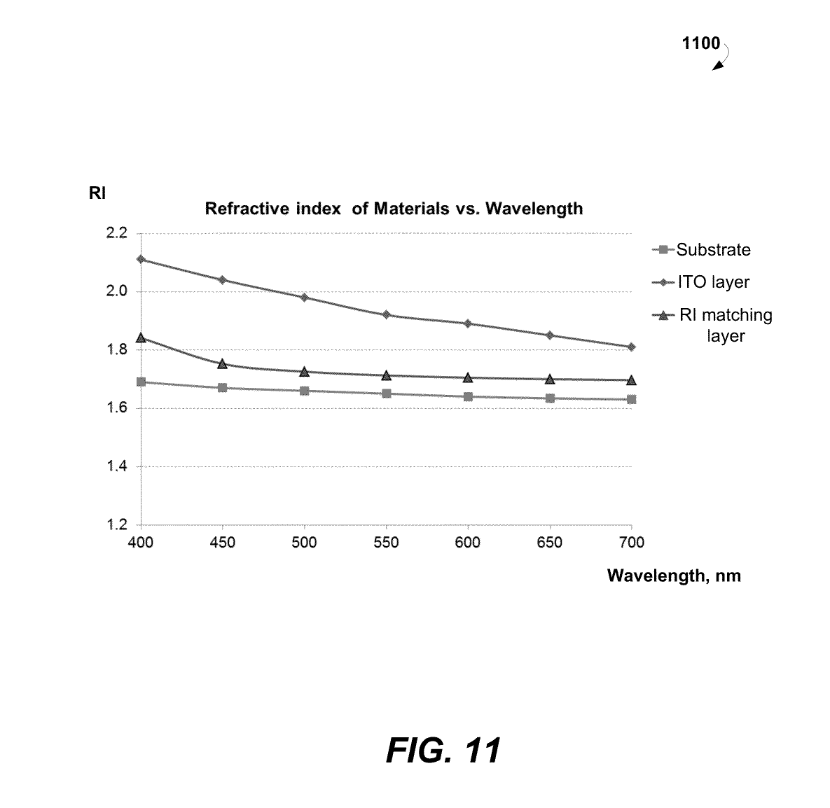

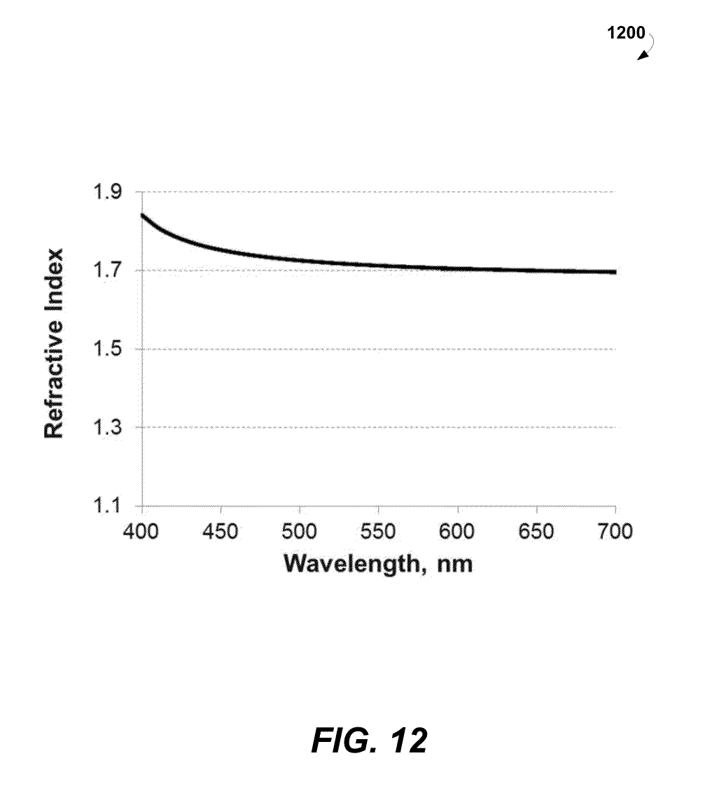

It should be also noted that the polymers discussed herein, which serve as a basis for refractive index-matching interlayers, have a very stable refractive index within a wide range of visible light. FIG. 11 shows an exemplary diagram of refractive index dependency for a substrate, e.g. a PET substrate, a TC electrode layer, an RI matching layer against a wavelength. It is obvious that the refractive index of the RI matching layer is consistent along a wide range of wavelengths. In-plane refractive index of the refractive index matching interlayers may be also substantially unchanged in a wide range of wavelengths, which is illustrated in FIG. 12.

### Optical Characteristics of Index Matching Layers

In a further example embodiment, a multilayer stack for a touchscreen display may comprise a substrate, a first RI matching layer deposited over a first surface of the substrate, and a TC electrode layer deposited onto the first RI matching layer. Furthermore, the multilayer stack may comprise a second RI matching layer deposited onto the TC electrode layer. The first RI matching layer and the second RI matching layer may include a polymer solution described above. The multilayer stack may further comprise a substantially transparent protection top layer deposited over the second RI matching layer.

Furthermore, a display device may be attached in immediate proximity to the second surface of the substrate. The display device may include an LCD, an OLED display, a light emitting device, and so forth. The refractive index of the first RI matching layer and the refractive index of the second refractive index matching layer may be selected to be between the refractive index of the TC electrode layer and the refractive index of the top layer.

The second RI matching layer may of a greater thickness than the first RI matching layer. The first RI matching layer of a greater thickness may provide reduction in reflection losses of the light emitting device in order to improve brightness of the touchscreen display. Furthermore, thickness of the second RI matching layer may be selected to provide obscuration of the TC electrode layer. Additionally, thickness of the second RI matching layer may be selected to provide substantially none or very little color shift of the touchscreen display.

### Refractive Index Matching Coating

### Example 7

Example 7 describes deposition and optical properties of the RI matching layer made of the polymer of Example 2, i.e. 2,2′-disulfo-4,4′-benzidine terephthalamide-isophthalamide copolymer cesium salt, structures (XI) and (XII) with p=0.7-0.75, q=0.3-0.25 Glass plates with a TC layer, in particular an ITO layer, patterned as a set of stripes having width of 300 μm and separated by 100 μm was used as a substrate. Thickness of the ITO layer was 60 nm. This patterning design is considered to be a standard for touch-screen devices. The substrates were cleaned in ultrasonic bath with 10 w % NaOH water solution for 30 minutes, then rinsed with deionized water for 10 minutes and dried with compressed air. Polymer coating was hand coated by a Mayer rod. The thickness of the coating was controlled by changing of the coating liquid concentration (1.5-8.0 w %) and the rod's number (#2.5-15). Thickness of dry films was measured with Dektak3st counting from the glass surface level. Considering the thickness of ITO layer, the coating thickness over ITO of 60 nm less than indicated was expected. Resulted films are typically a −C-plate, i.e. their principal refractive indices obey the following relation: nₓ=n_{y}>n_{z} (axes x and y are in the plane of the film, z is normal to the film). Particularly for this polymer nₓ=n_{y}=1.7, n_{z}=1.5.

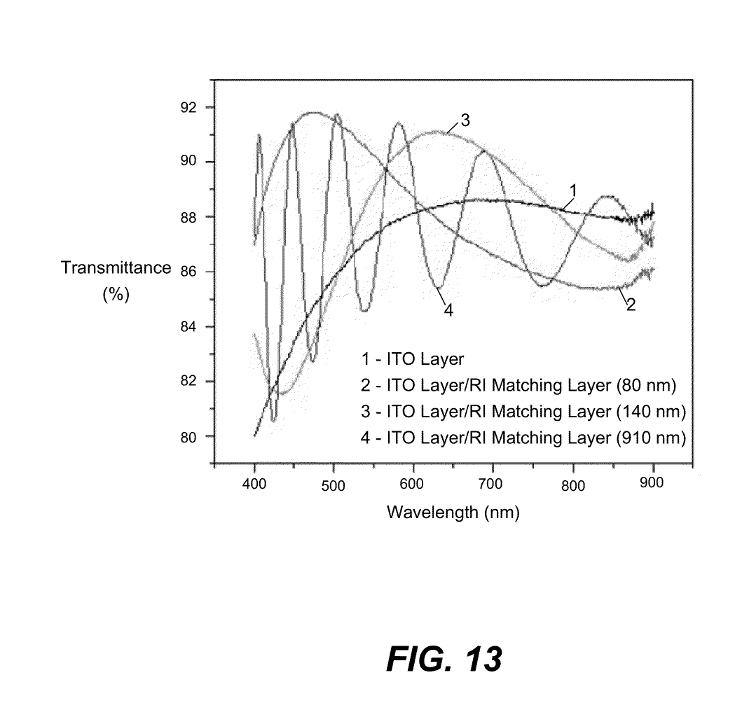

FIG. 13 shows transmission spectra of the samples of Example 7 taken using a spectrophotometer. The transmission spectrum of the ITO layer is marked as “1”. One can see that thin films, i.e. the films which thickness is comparable to a quarter wavelength (approx. 100 nm), suppress one part of the spectrum and are transparent in another part. That is why 80 nm films has red coloration (marked as “2”) in reflectance, whereas 140 nm films are bluish (marked as “3”). Thicker films, having more transparency maxima in visible appear colorless (marked as “4”).

### Antireflection Coating

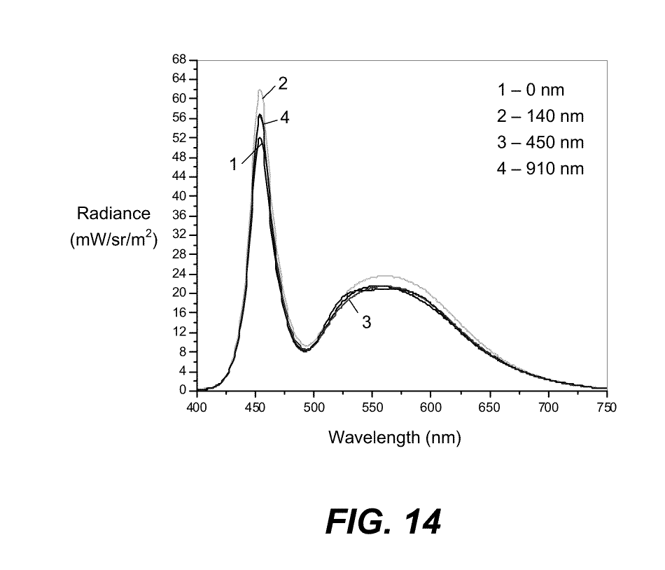

FIG. 14 shows spectral radiance of the samples of Example 7 and demonstrates antireflection and brightness enhancement effects of the samples from Example 7. Illumination effects were explored with the use of spectroradiometer PR730 (Photo Research). The samples were illuminated by a white LED placed behind a polymer diffuser. Spectral radiance and CIE 1931 chromaticity data is presented below.

TABLE 2
Change in luminance vs coating thickness

| # | Sample | Luminance (2°), cd/m² | Change, % |
|---|---|---|---|
| 1 | Bare ITO | 1315 | 0 |
| 2 | ITO/Polymer (140 nm) | 1487 | +9.9 |
| 3 | ITO/Polymer (450 nm) | 1320 | +0.4 |
| 4 | ITO/Polymer (910 nm) | 1325 | +0.8 |

The highest increase in luminance is observed with 140 nm coating, which minus ITO thickness corresponds to quarter-wave length value at 550 nm (80 nm). As can be seen on FIG. 14, presence of the polymer coating does not modify the spectrum.

### Spectral Radiance

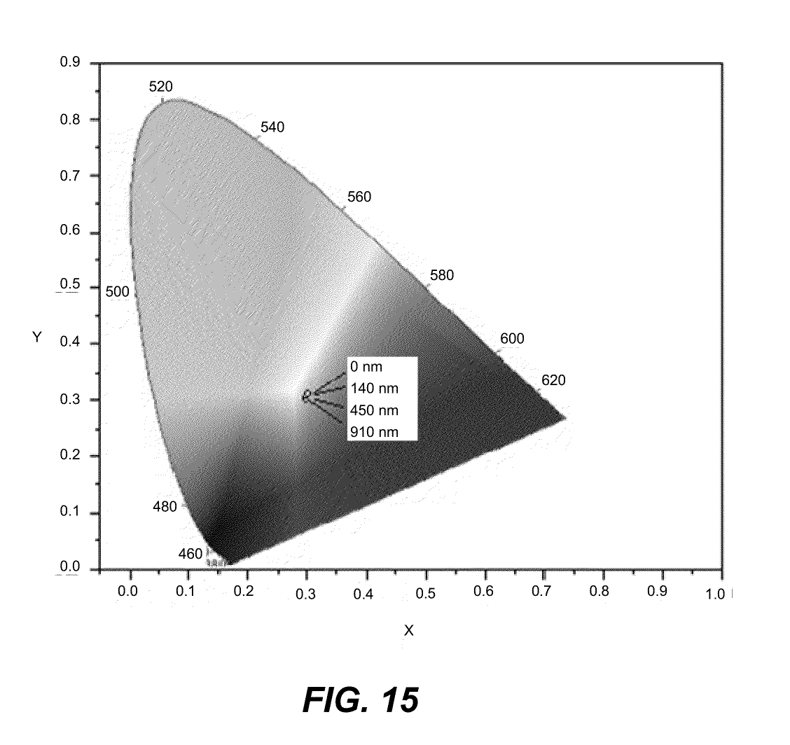

FIG. 15 shows CIE 1931 chromaticity diagram for the samples of Example 7. No significant color shift is observed. Color coordinates variation ΔxΔy is on the level of 10⁻² for the thickest coating. All the data is concentrated around the point determined by the LED used for measurements.

TABLE 3
CIE 1931 chromaticity coordinates

| Thickness, nm | 0 | 140 | 450 | 910 |
|---|---|---|---|---|
| x | 0.3097 | 0.3096 | 0.3036 | 0.2999 |
| y | 0.3044 | 0.3019 | 0.2989 | 0.3000 |
| ΔxΔy | 0 | 0.003 | 0.008 | 0.011 |

High in-plane refractive index makes these polymer films extremely promising for use as index matching coatings. For example, the issue of index matching of ITO (n=2.0) to underlying substrate (typically n=1.5) or various optical upper coatings (n=1.4-1.5) can be addressed by applying a layer of the polymer described in Example 2.

### CONCLUSION

Thus, various touch panel stacks and methods of forming such stacks involving deposition of specific RI matching interlayers for mitigating TC visibility with no color change have been disclosed. Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses disclosed herein. Accordingly, the present embodiments are to be considered as illustrative and not restrictive.

1. A multilayer stack for a touchscreen display, the multilayer stack comprising:
a substrate having a first surface and a second surface, wherein the first surface is opposite to the second surface;
a first refractive index matching layer deposited over the first surface of the substrate;
a first transparent conductive layer deposited onto the first refractive index matching layer;
a second refractive index matching layer deposited onto the second surface of the substrate; and
a second transparent conductive layer deposited over the second refractive index matching layer;
wherein the first refractive index matching layer and the second refractive index matching layer are based on a polymer solution.

2. The multilayer stack of claim 1, further comprising a substantially transparent protection layer provided adjacent to the second transparent conductive layer.

3. The multilayer stack of claim 2, further comprising a third refractive index matching layer deposited onto the second transparent conductive layer, wherein the third refractive index matching layer is located between the second transparent conductive layer and the substantially transparent protection layer.

4. The multilayer stack of claim 3, wherein a refractive index of the third refractive index matching layer is between a refractive index of the second transparent conductive layer and a refractive index of the substantially transparent protection layer.

4. The multilayer stack of claim 2, further comprising an air gap between the third refractive index matching layer and the substantially transparent protection layer.

5. The multilayer stack of claim 2, further comprising an index matching pressure sensitive adhesive deposited over the third refractive index matching layer, wherein the index matching pressure sensitive adhesive is located between the third refractive index matching layer and the substantially transparent protection layer.

6. The multilayer stack of claim 1, further comprising a light emitting device provided adjacent to the first transparent conductive layer.

7. The multilayer stack of claim 1, wherein a refractive index of the first refractive index matching layer is between a refractive index of the substrate and a refractive index of the first transparent conductive layer.

8. The multilayer stack of claim 1, wherein a refractive index of the second refractive index matching layer is between a refractive index of the substrate and a refractive index of the second transparent conductive layer.

9. The multilayer stack of claim 1, wherein a refractive index of the first refractive index matching layer differs from a refractive index of the second refractive index matching layer.

10. The multilayer stack of claim 1, wherein the first transparent conductive layer and the second transparent conductive layer provide touch sensitivity.

11. The multilayer stack of claim 1, wherein the polymer solution comprises at least a polymer, the polymer comprises n organic units having a following structural formula:
[-(Core(L)ₘ)ₖ-G₁-]ₙ,
wherein the organic units comprise rigid conjugated organic component Core, wherein G is a spacer selected from the group consisting of —C(O)—NR1-, ═(C(O))2=N—, —O—NR1-, linear and branched (C1-C4) alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein L are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3, and wherein k is 1, 2, or 3.

12. A multilayer stack for a touchscreen display, the multilayer stack comprising:
a substrate;
a refractive index matching layer deposited over the substrate, the refractive index matching layer being based on a polymer solution; and
a transparent conductive layer deposited over the refractive index matching layer, the transparent conductive layer providing touch sensitivity;
a display device in immediate proximity to the transparent conductive layer, wherein the display device includes a liquid crystal display (LCD) or an organic light emitting diode (OLED) display;
wherein a refractive index of the refractive index matching layer is between a refractive index of the substrate and a refractive index of the transparent conductive layer.

13. The multilayer stack of claim 12, further comprising an air gap between the display device and the transparent conductive layer.

14. The multilayer stack of claim 12, further comprising an index matching pressure sensitive adhesive deposited over the display device, wherein the index matching pressure sensitive adhesive is located between the display device and the transparent conductive layer.

15. The multilayer stack of claim 12, wherein the display device further includes a lower polarizer and an upper polarizer.

16. The multilayer stack of claim 12, wherein the polymer solution comprises at least a polymer, the polymer comprises n organic units having the following structural formula:
[-(Core(L)ₘ)ₖ-G₁-]ₙ,
wherein the organic units comprise rigid conjugated organic component Core, wherein G is a spacer selected from the group consisting of —C(O)—NR1-, ═(C(O))2=N—, —O—NR1-, linear and branched (C1-C4) alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein L are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3, and wherein k is 1, 2, or 3.

17. A method for forming a touchscreen display, the method comprising:
providing a substrate, the substrate including one or more of the following: a glass, a polyolefin, a polycarbonate, a polyamide, a polyimide, a cycloolefin polymer, a cycloolefin copolymer, a polyacryl, polystyrene, a PET (polyethylene terephthalate) based material, and a TAC (triacetyl cellulose) based material;
depositing a refractive index matching layer over the substrate, wherein the refractive index matching layer is based on a polymer solution;
depositing a transparent conductive layer over the refractive index matching layer, the transparent conductive layer providing touching sensitivity;
attaching a display device in immediate proximity to the transparent conductive layer, wherein the display device includes an LCD or an OLED display;
wherein a refractive index of the refractive index matching layer is between a refractive index of the substrate and a refractive index of the transparent conductive layer.

18. The method of claim 17, wherein the display device is attached so that there is an air gap between the display device and the transparent conductive layer.

19. The method of claim 17, further comprising depositing an index matching pressure sensitive adhesive over the display device so that the index matching pressure sensitive adhesive is located between the display device and the transparent conductive layer.

20. The method of claim 17, wherein the transparent conductive layer includes one or more of an indium tin oxide (ITO) based material, fluorine doped tin oxide (FTO) based material, silver nanowires, copper nanowires, and carbon nanotubes.

21. The method of claim 17, wherein the transparent conductive layer includes one or more conductive wire layers.

22. The multilayer stack of claim 17, wherein the polymer solution comprises at least a polymer and a solvent, wherein the polymer comprises n organic units having the following structural formula:
[-(Core(L)ₘ)ₖ-G₁-]ₙ,
wherein the organic units comprise rigid conjugated organic component Core, wherein G is a spacer selected from the group consisting of —C(O)—NR1-, ═(C(O))2=N—, —O—NR1-, linear and branched (C1-C4) alkylenes, —CR1R2-O—C(O)—CR1R2-, —C(O)—O—, —O—, and —NR1-, wherein R1 and R2 are independently selected from the group consisting of alkyl, alkenyl, alkynyl, and aryl; wherein L are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3, and wherein k is 1, 2, or 3.

23. The method of claim 22, further comprising removing the solvent from the polymer solution to form a dry polymer layer, wherein the removing of the solvent from the polymer solution includes one or more of the following processes: heating the polymer solution to at least 80° C., drying the polymer solution by subjecting to a drying gas flow, and drying the polymer solution using infrared light radiation or ultraviolet light radiation.

24. The method of claim 22, wherein the polymer includes a copolymer having two or more types of monomeric units.

25. The method of claim 22, wherein the n organic units further include one or more termination components connecting to the n organic units according to the following formula:
T-[-(Core(L)ₘ)ₖ-G₁-]ₙ-T,
wherein T includes one or more of alkenyl, alkynyl, and acrylic.

26. The method of claim 22, wherein the conjugated organic component Core includes one or more of the following structural formulas: 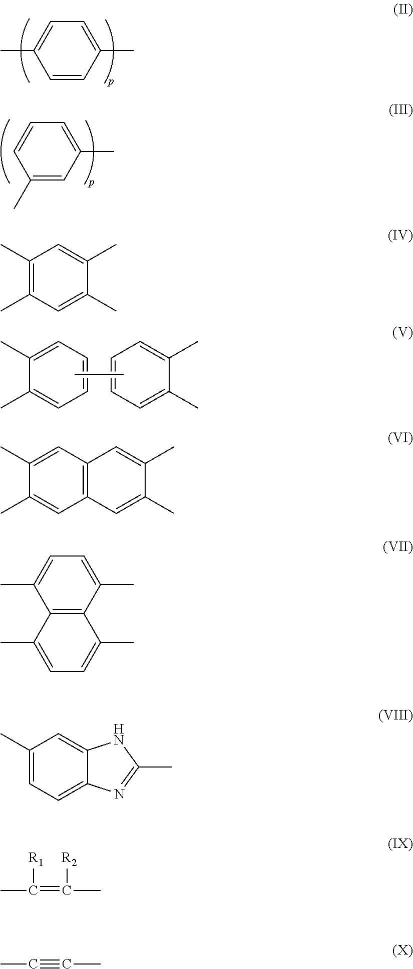
wherein p is an integer equal to 1, 2, 3, 4, 5, or 6 and R₁, R₂═H, alkyl.

27. The method of claim 22, further comprising pretreating the substrate to provide enhanced wettability or adhesion of the polymer solution.

28. The method of claim 27, wherein the pretreating of the base structure includes one or more of the following processes: saponification, leaching and oxidizing using mildly alkaline water solution, ultrasound cleaning, depositing at least one primer layer, wherein the at least one primer layer comprises one or more of silane and polyethylenimine, subjecting the base structure to corona discharge, and plasma treatment.

29. The method of claim 22, further comprising post-deposition treatment of the polymer solution with post-deposition solution, wherein the post-deposition solution is selected from the group consisting of: soluble salts of barium, lanthanum, aluminum, strontium and bismuth.

30. The method of claim 22, further comprising cross-linking the n organic units, wherein the cross-linking includes one or more of the following processes: ultraviolet light radiating of the polymer solution, infrared light radiating of the polymer solution, radiating of the polymer solution with an electron beam, radiating of the polymer solution with an ion beam, and radiating of the polymer solution with a gamma beam.

31. The method of claim 22, wherein the depositing of the refractive index matching layer includes one or more of the following techniques: slot die extrusion, Mayer rod coating, roll coating, gravure coating, micro-gravure coating, comma coating, knife coating, extrusion, printing, spray coating, and dip coating.

32. A multilayer stack for a touchscreen display, the multilayer stack comprising:
a substrate having a first surface and a second surface, wherein the first surface is opposite to the second surface;
a first refractive index matching layer deposited over the first surface of the substrate;
a transparent conductive layer deposited onto the first refractive index matching layer; and
a second refractive index matching layer deposited onto the transparent conductive layer, wherein the first refractive index matching layer and the second refractive index matching layer are based on a polymer solution.

33. The multilayer stack of claim 32, further comprising a substantially transparent protection layer deposited over the second refractive index matching layer.

34. The multilayer stack of claim 33, wherein a refractive index of the first refractive index matching layer and a refractive index of the second refractive index matching layer are disposed between a refractive index of the transparent conductive layer and a refractive index of the substantially transparent protection layer.

35. The multilayer stack of claim 32, wherein a thickness of the second refractive index matching layer is greater than the a thickness of the first refractive index matching layer.

36. The multilayer stack of claim 32, further comprising a display device in immediate proximity to the second surface of the substrate.

37. The multilayer stack of claim 36, wherein the display device includes a liquid crystal display (LCD), organic light emitting diode (OLED) display, or a light emitting device.

38. The multilayer stack of claim 32, wherein the first refractive index matching layer provides reduction of reflection losses of the light emitting device to improve brightness of the touchscreen display.

39. The multilayer stack of claim 32, wherein a thickness of the second refractive index matching layer is selected to provide obscuration of the transparent conductive layer.

40. The multilayer stack of claim 32, wherein a thickness of the second refractive index matching layer is selected so as to provide substantially close to zero color shift of the touchscreen display.

41. The multilayer stack of claim 32, wherein the polymer solution comprises at least a polymer, the polymer comprises n organic units having the following structural formula:
[-(Core(L)m)k-G1-]n,
wherein the organic units comprise rigid conjugated organic component Core, wherein G is a spacer selected from the group consisting of —C(O)—NR1-, ═(C(O))2=N—, —O—NR1-, linear and branched (C1-C4) alkylenes, —CR1R2-O—C(O)—CR1R2-, —C(O)—O—, —O—, and —NR1-, wherein R1 and R2 are independently selected from the group consisting of H, alkyl, alkenyl, alkynyl, and aryl; wherein L are lyophilic side-groups providing solubility to the polymer in the solvent and which are the same or different and independently selected from the group consisting of —COOX, —SO₃X, wherein X is selected from the group consisting of H, alkyl, alkenyl, alkynyl, aryl, alkali metal, and NW₄, wherein W is H or alkyl or any combination thereof, —SO₂NP1P2 and —CONP1P2, wherein P1 and P2 are independently selected from the group consisting of H, alkyl, alkenyl, alkynyl, and aryl; and wherein m is 0, 1, 2, or 3, and wherein k is 1, 2, or 3.
